(19) United States
(12) Patent Application Publication
(10) Pub. No.: US 2007/0148061 A1
(43) Pub. Date: Jun. 28, 2007

(54) Electro-kinetic air transporter and/or air conditioner with devices with features for cleaning emitter electrodes

(75) Inventors: Shek Fai Lau, Foster City, CA (US); Andrew J. Parker, Novato, CA (US); Charles E. Taylor, Punta Gorda, FL (US); Gregory S. Snyder, San Rafael, CA (US); John Paul Reeves, Hong Kong (HK)

Correspondence Address: BELL, BOYD & LLOYD LLP, P.O. BOX 1135, CHICAGO, IL, 60690, US

(73) Assignee: The Sharper Image Corporation, San Francisco, CA (US)

(21) Appl. No.: 11/464,139

(22) Filed: Aug. 11, 2006

Related U.S. Application Data
(63) Continuation-in-part of application No. 10/023,197, filed on Dec. 13, 2001, now abandoned.
(63) Continuation of application No. 09/730,499, filed on Dec. 5, 2000, now Pat. No. 6,713,026.
Application No. 09/730,499 is a continuation of application No. 09/186,471, filed on Nov. 5, 1998, now Pat. No. 6,176,977.
(63) Continuation-in-part of application No. 10/419,437, filed on Apr. 21, 2003, now abandoned.
Application No. 10/419,437 is a division of application No. 09/924,624, filed on Aug. 8, 2001, now abandoned.
Application No. 09/924,624 is a continuation of application No. 09/564,960, filed on May 4, 2000, now Pat. No. 6,350,417.
Application No. 09/564,960 is a continuation-in-part of application No. 09/186,471, filed on Nov. 5, 1998, now Pat. No. 6,176,977.
(63) Continuation-in-part of application No. 10/685,182, filed on Oct. 14, 2003.
(63) Continuation-in-part of application No. 10/349,623, filed on Apr. 24, 2003, now abandoned.
Application No. 10/349,623 is a continuation of application No. 09/924,624, filed on Aug. 8, 2001, now abandoned.
Application No. 09/924,624 is a continuation of application No. 09/564,960, filed on May 4, 2000, now Pat. No. 6,350,417.
Application No. 09/564,960 is a continuation-in-part of application No. 09/186,471, filed on Nov. 5, 1998, now Pat. No. 6,176,977.
(63) Continuation-in-part of application No. 10/823,346, filed on Apr. 12, 2004.
(63) Continuation-in-part of application No. 11/061,967, filed on Feb. 18, 2005.
(63) Continuation-in-part of application No. 11/062,173, filed on Feb. 18, 2005.
(60) Provisional application No. 60/306,479, filed on Jul. 18, 2001.
(60) Provisional application No. 60/470,519, filed on May 14, 2003.
(60) Provisional application No. 60/545,698, filed on Feb. 18, 2004.
(60) Provisional application No. 60/545,698, filed on Feb. 18, 2004.
(60) Provisional application No. 60/579,481, filed on Jun. 14, 2004.

(51) Int. Cl. B01J 19/08

(52) U.S. Cl. 422/186.04

(57) ABSTRACT

An electro-kinetic electro-static air conditioner that can include a self-contained ion generator that provides electro-kinetically moved air with ions. The ion generator can include a high voltage pulse generator whose output pulses are coupled between first and second electrode arrays. An air conditioner device can include a first electrode array and a second electrode array. Self-cleaning mechanisms are disclosed including a mechanism that cleans the electrode(s) in a first electrode array having a length of material that projects from a movable member in the housing towards the first electrode array. As a user moves the second electrode array up or down within the conditioner housing, the electrode(s) in the first array is frictionally cleaned.

### PRIORITY CLAIM

This application is a continuation in part of application Ser. No. 10/023,197, which claims priority from provisional Application No. 60/306,479, filed Jul. 18, 2001, which is a continuation of U.S. patent application Ser. No. 09/730,499 filed Dec. 5, 2000, which is a continuation of U.S. patent application Ser. No. 09/186,471 filed Nov. 5, 1998, now U.S. Pat. No. 6,176,977.

This application is a continuation in part of application Ser. No. 10/419,437, which is a divisional of U.S. patent application Ser. No. 09/924,624 filed Aug. 8, 2001, which is a continuation of U.S. patent application Ser. No. 09/564,960 filed May 4, 2000 (now U.S. Pat. No. 6,350,417) which is a continuation-in-part of U.S. patent application Ser. No. 09/186,471, filed Nov. 5, 1998 (now U.S. Pat. No. 6,176,977).

This application is a continuation in part of application Ser. No. 10/685,182 and 10/349,623, which are continuations of U.S. patent application Ser. No. 09/924,624, filed Aug. 8, 2001, which is a continuation of U.S. patent application Ser. No. 09/564,960 (now U.S. Pat. No. 6,350,417), filed May 6, 2000, which is a continuation-in-part from U.S. application Ser. No. 09/186,471 (now U.S. Pat. No. 6,176,977), filed Nov. 5, 1998.

This application is a continuation in part of application Ser. No. 10/823,346, which claims priority from U.S. Provisional Patent Application No. 60/470,519, filed May 14, 2003.

This application is a continuation in part of application Ser. No. 11/061,967, which claims priority from U.S. Provisional Patent Application No. 60/545,698, filed Feb. 18, 2004.

This application is a continuation in part of application Ser. No. 11/062,173, which claims priority of U.S. Provisional Patent Application Ser. No. 60/545,698, filed Feb. 18, 2004, and U.S. Provisional Patent Application Ser. No. 60/579,481, filed Jun. 14, 2004.

All of the above applications and are hereby incorporated herein by reference.

### BACKGROUND

This invention relates generally to devices that produce ozone and an electro-kinetic flow of air from which particulate matter has been substantially removed, and more particularly to cleaning the wire or wire-like electrodes present in such devices.

The use of an electric motor to rotate a fan blade to create an air flow has long been known in the art. Unfortunately, such fans produce substantial noise, and can present a hazard to children who may be tempted to poke a finger or a pencil into the moving fan blade. Although such fans can produce substantial air flow, e.g., 1,000 ft³/minute or more, substantial electrical power is required to operate the motor, and essentially no conditioning of the flowing air occurs.

It is known to provide such fans with a HEPA-compliant filter element to remove particulate matter larger than perhaps 0.3 μm. Unfortunately, the resistance to air flow presented by the filter element may require doubling the electric motor size to maintain a desired level of airflow. Further, HEPA-compliant filter elements are expensive, and can represent a substantial portion of the sale price of a HEPA-compliant filter-fan unit. While such filter-fan units can condition the air by removing large particles, particulate matter small enough to pass through the filter element is not removed, including bacteria, for example.

It is also known in the art to produce an air flow using electro-kinetic techniques, by which electrical power is directly converted into a flow of air without mechanically moving components. One such system is described in U.S. Pat. No. 4,789,801 to Lee (1988), depicted herein in simplified form as FIGS. 1A and 1B, as well as in U.S. Pat. No. 6,176,977 to Taylor et al. (2001). Lee's system 10 includes an array of small area (“minisectional”) electrodes 20 that is spaced-apart symmetrically from an array of larger area (“maxisectional”) electrodes 30. The positive terminal of a pulse generator 40 that outputs a train of high voltage pulses (e.g., 0 to perhaps+5 KV) is coupled to the minisectional array, and the negative pulse generator terminal is coupled to the maxisectional array.

The high voltage pulses ionize the air between the arrays, and an air flow 50 from the minisectional array toward the maxisectional array results, without requiring any moving parts. Particulate matter 60 in the air is entrained within the airflow 50 and also moves towards the maxisectional electrodes 30. Much of the particulate matter is electrostatically attracted to the surface of the maxisectional electrode array, where it remains, thus conditioning the flow of air exiting system 10. Further, the high voltage field present between the electrode arrays can release ozone into the ambient environment, which appears to destroy or at least alter whatever is entrained in the airflow, including for example, bacteria.

In the embodiment of FIG. 1A, minisectional electrodes 20 are circular in cross-section, having a diameter of about 0.003″ (0.08 mm), whereas the maxisectional electrodes 30 are substantially larger in area and define a “teardrop” shape in cross-section. The ratio of cross-sectional radii of curvature between the maxisectional and minisectional electrodes is not explicitly stated, but from Lee's figures appears to exceed 10:1. As shown in FIG. 1A herein, the bulbous front surfaces of the maxisectional electrodes face the minisectional electrodes, and the somewhat sharp trailing edges face the exit direction of the air flow. The “sharpened” trailing edges on the maxisectional electrodes apparently promote good electrostatic attachment of particular matter entrained in the airflow. Lee does not disclose how the teardrop shaped maxisectional electrodes are fabricated, but presumably they are produced using a relatively expensive mold-casting or an extrusion process.

In another embodiment shown herein as FIG. 1B, Lee's maxisectional sectional electrodes 30 are symmetrical and elongated in cross-section. The elongated trailing edges on the maxisectional electrodes provide increased area upon which particulate matter entrained in the airflow can attach. Lee states that precipitation efficiency and desired reduction of anion release into the environment can result from including a passive third array of electrodes 70. Understandably, increasing efficiency by adding a third array of electrodes will contribute to the cost of manufacturing and maintaining the resultant system.

While the electrostatic techniques disclosed by Lee are advantageous over conventional electric fan-filter units, Lee's maxisectional electrodes are relatively expensive to fabricate. Further, increased filter efficiency beyond what Lee's embodiments can produce would be advantageous, especially without including a third array of electrodes.

Thus, there is a need for an electro-kinetic air transporter-conditioner that provides improved efficiency over Lee-type systems, without requiring expensive production techniques to fabricate the electrodes. Preferably such a conditioner should function efficiently without requiring a third array of electrodes. Further, such a conditioner should permit user-selection of safe amounts of ozone to be generated, for example to remove odor from the ambient environment.

The present invention provides a method and apparatus for electro-kinetically transporting and conditioning air.

The present invention provides a first and second electrode array configuration electro-kinetic air transporter-conditioner having improved efficiency over Lee-type systems, without requiring expensive production techniques to fabricate the electrodes. The condition also permitted user-selection of safe amounts of ozone to be generated.

The second array electrodes are intended to collect particulate matter, and to be user-removable from the transporter-conditioner for regular cleaning to remove such matter from the electrode surfaces. The user must take care, however, to ensure that if the second array electrodes were cleaned with water, that the electrodes are thoroughly dried before reinsertion into the transporter-conditioner unit. If the unit were turned on while moisture from newly cleaned electrodes was allowed to pool within the unit, and moisture wicking could result in high voltage arcing from the first to the second electrode arrays, with possible damage to the unit.

The wire or wire-like electrodes in the first electrode array are less robust than the second array electrodes. (The terms “wire” and “wire-like” shall be used interchangeably herein to mean an electrode either made from a wire or, if thicker or stiffer than a wire, having the appearance of a wire.) In embodiments in which the first array electrodes were user-removable from the transporter-conditioner unit, care was required during cleaning to prevent excessive force from simply snapping the wire electrodes. But eventually the first array electrodes can accumulate a deposited layer or coating of fine ash-like material. If this deposit is allowed to accumulate, eventually efficiency of the conditioner-transporter will be degraded. Further, for reasons not entirely understood, such deposits can produce an audible oscillation that can be annoying to persons near the conditioner-transporter.

Thus, there is also a need for a mechanism by a conditioner-transporter unit that can be protected against moisture pooling in the unit as a result of user cleaning. Further, there is a need for a mechanism by which the wire electrodes in the first electrode array of a conditioner-transporter can be periodically cleaned. Preferably such cleaning mechanism should be straightforward to implement, should not require removal of the first array electrodes from the conditioner-transporter, and should be operable by a user on a periodic basis.

The present invention provides a method and apparatus.

### SUMMARY

An electro-kinetic system for transporting and conditioning air without moving parts is disclosed. The air is conditioned in the sense that it is ionized and made to contain safe amounts of ozone. The electro-kinetic air transporter-conditioner disclosed herein includes a louvered or grilled body that houses an ionizer unit. The ionizer unit can include a high voltage DC inverter that boosts common 110 VAC to high voltage, and a generator that receives the high voltage DC and outputs high voltage pulses of perhaps 10 KV peak-to-peak, although an essentially 100% duty cycle (e.g., high voltage DC) output could be used instead of pulses. The unit can also include an electrode assembly unit comprising first and second spaced-apart arrays of conducting electrodes, the first array and second array being coupled, respectively, preferably to the positive and negative output ports of the high voltage generator.

The electrode assembly can be formed using first and second arrays of readily manufacturable electrode configurations. In certain embodiments the first array can include wire (or wire-like) electrodes. The second array can comprise “U”-shaped or “L”-shaped electrodes having one or two trailing surfaces and intentionally large outer surface areas upon which to collect particulate matter in the air. In the preferred embodiments, the ratio between effective radii of curvature of the second array electrodes to the first array electrodes is at least about 20:1.

The high voltage pulses can create an electric field between the first and second electrode arrays. This field can produce an electro-kinetic airflow going from the first array toward the second array, the airflow being rich in preferably a net surplus of negative ions and in ozone. Ambient air including dust particles and other undesired components (germs, perhaps) enter the housing through the grill or louver openings, and ionized clean air (with ozone) exits through openings on the downstream side of the housing.

The dust and other particulate matter attaches electrostatically to the second array (or collector) electrodes, and the output air contains lower amounts of such particulate matter. Further, ozone generated by the transporter-conditioner unit can kill certain types of germs and the like, and also eliminates odors in the output air. Preferably the transporter operates in periodic bursts, and a control permits the user to temporarily increase the high voltage pulse generator output, e.g., to more rapidly eliminate odors in the environment.

Also disclosed are second array electrode units that are very robust and user-removable from the transporter-conditioner unit for cleaning. These second array electrode units could simply be slid up and out of the transporter-conditioner unit, and wiped clean with a moist cloth, and returned to the unit. However, on occasion, if electrode units are returned to the transporter-conditioner unit while still wet (from cleaning), moisture pooling can reduce resistance between the first and second electrode arrays to where high voltage arcing results.

Another problem is that over time the wire electrodes in the first electrode array become dirty and can accumulate a deposited layer or coating of fine ash-like material. This accumulated material on the first array electrodes can eventually reduce ionization efficiency. Further, this accumulated coating can also result in the transporter-conditioner unit producing 500 Hz to 5 KHz audible oscillations that can annoy people in the same room as the unit.

In an embodiment, the present invention extends one or more thin flexible sheets of MYLAR or KAPTON type material from the lower portion of the removable second array electrode unit. This sheet or sheets faces the first array electrodes and is nominally in a plane perpendicular to the longitudinal axis of the first and second array electrodes. Such sheet material has high voltage breakdown, high dielectric constant, can withstand high temperature, and is flexible. A slit is cut in the distal edge of this sheet for each first array electrode such that each wire first array electrode fits into a slit in this sheet. Whenever the user removes the second electrode array from the transporter-conditioner unit, the sheet of material is also removed. However, in the removal process, the sheet of material is also pulled upward, and friction between the inner slit edge surrounding each wire tends to scrape off any coating on the first array electrode. When the second array electrode unit is reinserted into the transporter-conditioner unit, the slits in the sheet automatically surround the associated first electrode array electrode. Thus, there is an up and down scraping action on the first electrode array electrodes whenever the second array electrode unit is removed from, or simply moved up and down within, the transporter-conditioner unit.

Optionally, upwardly projecting pillars can be disposed on the inner bottom surface of the transporter-conditioner unit to deflect the distal edge of the sheet material upward, away from the first array electrodes when the second array electrode unit is fully inserted. This feature reduces the likelihood of the sheet itself lowering the resistance between the two electrode arrays. In an embodiment, the lower ends of the second array electrodes are mounted to a retainer that includes pivotable arms to which a strip of a solid material, such as MYLAR OR KAPTON is attached. The distal edge of each strip includes a slit, and each strip (and the slit therein) is disposed to self-align with an associated wire electrode. A pedestal extends downward from the base of the retainer, and when fully inserted in the transporter-conditioner unit, the pedestal extends into a pedestal opening in a sub-floor of the unit. The first electrode array-facing walls of the pedestal opening urge the arms and the strip on each arm to pivot upwardly, from a horizontal to a vertical disposition. This configuration can improve resistance between the electrode arrays.

Yet another embodiment provides a cleaning mechanism for the wires in the first electrode array in which one or more bead-like members surrounds each wire, the wire electrode passing through a channel in the bead. When the transporter-conditioner unit is inverted, top-for-bottom and then bottom-for-top, the beads slide the length of the wire they surround, scraping off debris in the process. The bead embodiments maybe combined with any or all of the various sheets embodiments to provide mechanisms allowing a user to safely clean the wire electrodes in the first electrode array in a transporter-conditioner unit.

In another embodiment, an air cleaner having at least an emitter electrode and at least a collector electrode, a bead or other object having a bore there through, with the emitter electrode provided through said bore of the bead or other object is provided. A bead or object moving arm can be provided with the air cleaner and can be operatively associated with the bead or object, in order to move the bead or object relative to the emitter electrode in order to clean the emitter electrode.

In another embodiment, the collector electrode can be removable from the air-cleaner for cleaning and the bead or object moving arm can be operatively associated with the collector electrode such that the collector electrode is removed from the air cleaner, the bead or object moving arm moves said bead or object in order to clean said emitter electrode.

In another embodiment, the air cleaner includes a housing with a top and a base, wherein the collector electrode can be movable through the top in order to be cleaned, and wherein such collector electrode can be removed from the top and said bead or object moving arm moves said bead or object towards the top in order to clean the emitter electrode.

In another embodiment, the emitter electrode has a bottom end stop on which said bead can rest when the bead is at the bottom of the emitter electrode. The bead moving arm can be moveably mounted to the collector electrode such that with the bead or object resting on said bottom end stop, said bead or object moving arm can move past said bead or object and reposition under said bead or object in preparation for moving said bead or object to clean said emitter electrode.

In another embodiment, a method to clean an air-cleaner, which air cleaner has a housing with a top and base, and wherein said air cleaner includes a first electrode, a second electrode array, and a bead or object mounted on the first electrode and a bead or object moving arm mounted on the second electrode array, can include the steps of removing said second electrode array from the top of said housing, and simultaneously moving said bead or object along the first electrode as urged by the bead or object moving arm in order to clean said first electrode.

A further aspect of the invention includes insulation of main elements to prevent high voltage arcing, namely the pylons that support the emitter electrodes, the barrier wall between the emitter and collector electrodes and adjacent to the collector electrodes, or the lip on the upper edge of the barrier wall, and the beads used for cleaning the emitter electrodes. In particular, care is taken to prevent high voltage arcing caused by insects attracted to the UV light from a UV light source. Accordingly, in this embodiment of the invention, insulation is used either to cast or coat the barrier wall and the pylons to avoid electrical discharge.

Other features and advantages of the invention will appear from the following description in which the preferred embodiments have been set forth in detail, in conjunction with the accompanying drawings.

Additional features and advantages are described herein, and will be apparent from, the following Detailed Description and the figures.

### BRIEF DESCRIPTION OF THE FIGURES

FIG. 1A is a plan, cross-sectional view, of a first embodiment of a prior art electro-kinetic air transporter-conditioner system, according to the prior art.

FIG. 1B is a plan, cross-sectional view, of a second embodiment of a prior art electro-kinetic air transporter-conditioner system, according to the prior art.

FIG. 2B is a perspective view of the embodiment of FIG. 2A, with the second array electrode assembly partially withdrawn depicting a mechanism for self-cleaning the first array electrode assembly, according to the present invention.

FIG. 3 is an electrical block diagram of the present invention.

FIG. 4A is a perspective block diagram showing a first embodiment for an electrode assembly, according to the present invention.

FIG. 4B is a plan block diagram of the embodiment of FIG. 4A.

FIG. 4C is a perspective block diagram showing a second embodiment for an electrode assembly, according to the present invention.

FIG. 4D is a plan block diagram of a modified version of the embodiment of FIG. 4C.

FIG. 4E is a perspective block diagram showing a third embodiment for an electrode assembly, according to the present invention.

FIG. 4F is a plan block diagram of the embodiment of FIG. 4E.

FIG. 4G is a perspective block diagram showing a fourth 5 embodiment for an electrode assembly, according to the present invention.

FIG. 4H is a plan block diagram of the embodiment of FIG. 4G.

FIG. 4I is a perspective block diagram showing a fifth embodiment for an electrode assembly, according to the present invention.

FIG. 4J is a detailed cross-sectional view of a portion of the embodiment of FIG. 41.

FIG. 4K is a detailed cross-sectional view of a portion of an alternative to the embodiment of FIG. 4I.

FIG. 5A is a perspective view of an electrode assembly depicting a first embodiment of a mechanism to clean first electrode array electrodes, according to the present invention.

FIG. 5B is a side view depicting an electrode cleaning mechanism as shown in FIG. 5A, according to the present invention.

FIG. 5C is a plan view of the electrode cleaning mechanism shown in FIG. 5B, according to the present invention.

FIG. 6A is a perspective view of a pivotable electrode cleaning mechanism, according to the present invention.

FIGS. 6B-6D depict the cleaning mechanism of FIG. 6A in various positions, according to the present invention.

FIGS. 7A-7E depict cross-sectional views of bead-like mechanisms to clean first electrode array electrodes, according to the present invention.

FIG. 8A depicts a cross sectional view of another embodiment of a cleaning mechanism of the invention illustrating a bead positioned atop a bead lifting arm.

FIG. 8B depicts a cut away view of the embodiment of the invention of FIG. 8A illustrating the bead lifting arm.

FIG. 8C depicts a perspective view of the embodiment of the invention depicted in FIGS. 8A and 8B.

FIG. 8D depicts a perspective view of the embodiment of the invention illustrated in FIGS. 8A, 8B, and 8C, and depicting an insulated barrier, lip of barrier, and pylons.

FIG. 9 illustrates a perspective view of an exemplary electro-kinetic conditioner system.

FIG. 10 illustrates a perspective view of a wire loop emitter electrode cleaning system in accordance with one embodiment of the present invention.

FIG. 11 illustrates a cross-sectional view of the cleaning system along line 3-3 in FIG. 10 in accordance with another embodiment of the present invention.

FIG. 12 illustrates a top view of another emitter electrode cleaning assembly in accordance with one embodiment of the present invention.

FIG. 13 illustrates a perspective view of a wire loop emitter electrode cleaning system in accordance with one embodiment of the present invention.

FIGS. 14-16 illustrate various mechanisms for removing debris from the wire loop emitter electrodes in accordance with embodiments of the present invention.

FIGS. 17 and 18 illustrate an exemplary electro-kinetic conditioner system

FIG. 19 illustrates an electro-kinetic conditioner system that includes wire loop emitter electrodes, in accordance with embodiments of the present invention.

FIGS. 20-22 illustrate various mechanisms for removing debris from the wire loop emitter electrodes of FIG. 2A, in accordance with embodiments of the present invention.

FIG. 23 illustrates an embodiment of the present invention in which a wire emitter electrode is unwound from one spool and wound onto another spool, according to an embodiment of the present invention.

FIGS. 24-28 illustrate embodiments of the present invention where a spring is used to move, and more specifically project, a cleaning member along an emitter electrode.

FIGS. 29 and 30 illustrate embodiments of the present invention where a lever mechanism is used to move, and more specifically project, a cleaning member along an emitter electrode.

FIGS. 31 and 32 are top views of exemplary levers that can be used in the embodiments shown in FIGS. 27 and 28.

FIGS. 33-35 illustrate embodiments of the present invention where a plucker is used to vibrate an emitter electrode.

FIGS. 36 and 37 illustrate embodiments of the present invention where a vibrating unit is used to vibrate an emitter electrode.

FIG. 38 illustrates embodiments of the present invention where a current control circuit is used to heat an emitter electrode.

FIG. 39 is a block diagram of an exemplary circuit used to the drive and control an electro-kinetic conditioner system, according to embodiments of the present invention.

### DETAILED DESCRIPTION

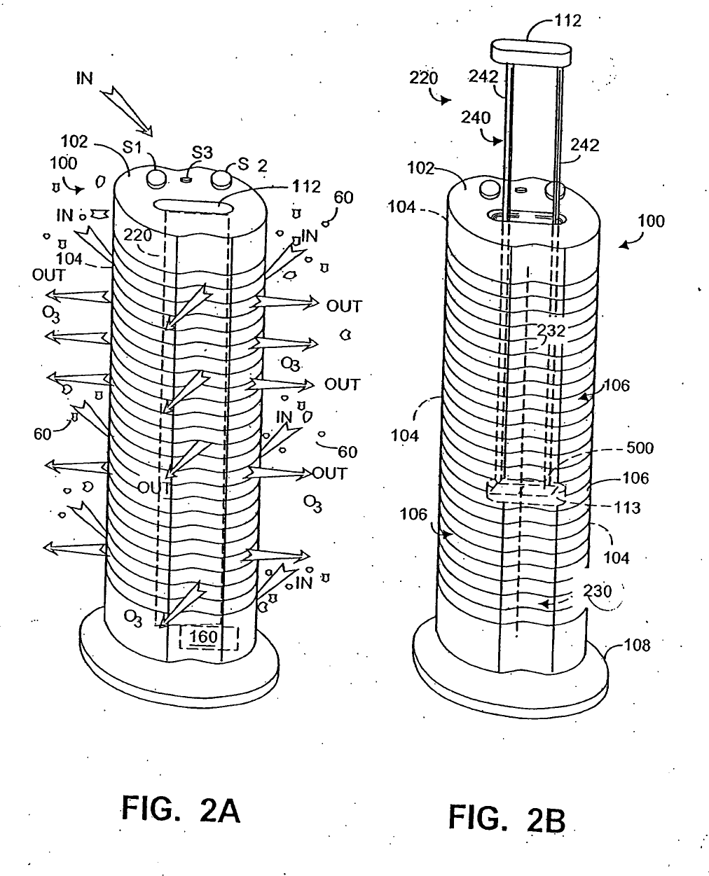

FIGS. 2A and 2B depict an electro-kinetic air transporter-conditioner system 100 whose housing 102 includes preferably rear-located intake vents or louvers 104 and preferably front and side-located exhaust vents 106, and a base pedestal 108. Internal to the transporter housing is an ion generating unit 160, preferably powered by an AC:DC power supply that is energizable or excitable using switch S1. Ion generating unit 160 is self-contained in that other than ambient air, nothing is required from beyond the transporter housing, save external operating potential, for operation of the present invention.

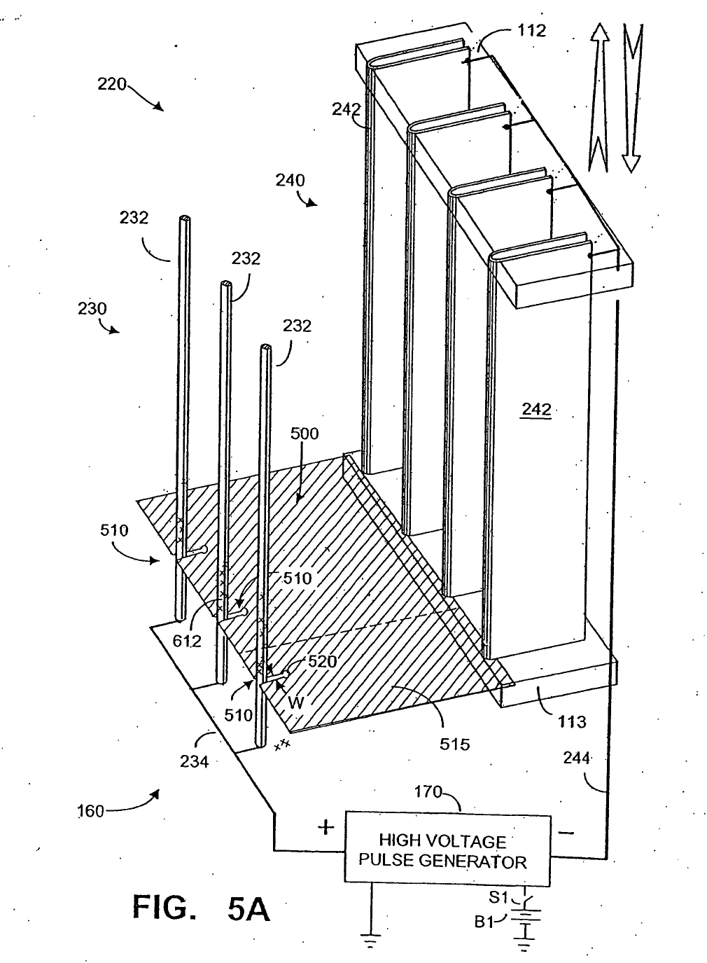

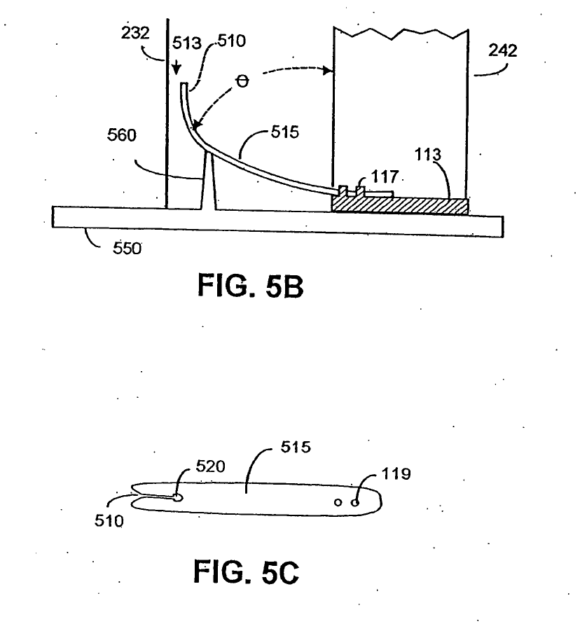

The upper surface of housing 102 includes a user-liftable handle member 112 to which is affixed a second array 240 of electrodes 242 within an electrode assembly 220. Electrode assembly 220 also comprises a first array of electrodes 230, shown here as a single wire or wire-like electrode 232. In the embodiment shown, lifting member 112 upward lifts second array electrodes 240 up and, if desired, out of unit 100, while the first electrode array 230 remains within unit 100. In FIG. 2B, the bottom ends of second array electrode 242 are connected to a member 113, to which is attached a mechanism 500 for cleaning the first electrode array electrodes, here electrode 232, whenever handle member 112 is moved upward or downward by a user. FIGS. 5A-7E, described later herein, provide further details as to various mechanisms 500 for cleaning wire or wire-like electrodes 232 in the first electrode array 230, and for maintaining high resistance between the first and second electrode arrays 220, 230 even if some moisture is allowed to pool within the bottom interior of unit 100.

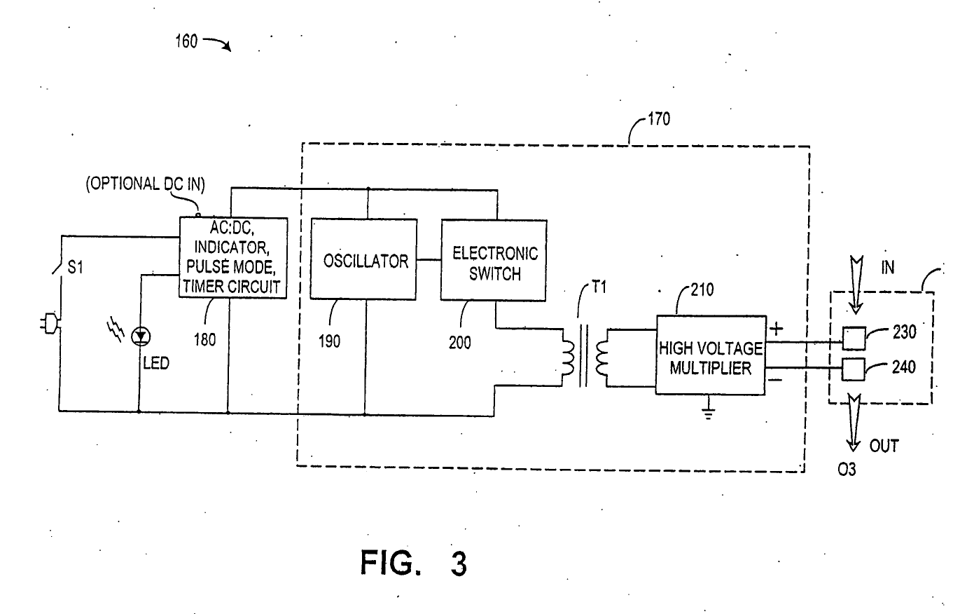

The first and second arrays of electrodes are coupled in series between the output terminals of ion generating unit 160, as best seen in FIG. 3. The ability to lift handle 112 provides ready access to the electrodes comprising the electrode assembly, for purposes of cleaning and, if necessary, replacement.

The general shape of the invention shown in FIGS. 2A and 2B is not critical. The top-to-bottom height of the preferred embodiment is perhaps 1 m, with a left-to-right width of perhaps 15 cm, and a front-to-back depth of perhaps 10 cm, although other dimensions and shapes may of course be used. A louvered construction provides ample inlet and outlet venting in an economical housing configuration. There need be no real distinction between vents 104 and 106, except their location relative to the second array electrodes, and indeed a common vent could be used. These vents serve to ensure that an adequate flow of ambient air maybe drawn into or made available to the unit 100, and that an adequate flow of ionized air that includes safe amounts of 0₃ flows out from unit 130.

As will be described, when unit 100 is energized with S1, high voltage output by ion generator 160 produces ions at the first electrode array, which ions are attracted to the second electrode array. The movement of the ions in an “IN” to “OUT” direction carries with them air molecules, thus electro kinetically producing an outflow of ionized air. The “IN” notion in FIGS. 2A and 2B denote the intake of ambient air with particulate matter 60. The “OUT” notation in the figures denotes the outflow of cleaned air substantially devoid of the particulate matter, which adheres electrostatically to the surface of the second array electrodes. In the process of generating the ionized air flow, safe amounts of ozone (0₃) are beneficially produced. It may be desired to provide the inner surface of housing 102 with an electrostatic shield to reduces detectable electromagnetic radiation. For example, a metal shield could be disposed within the housing, or portions of the interior of the housing could be coated with a metallic paint to reduce such radiation.

As best seen in FIG. 3, ion generating unit 160 includes a high voltage generator unit 170 and circuitry 180 for converting raw alternating voltage (e.g., 117 VAC) into direct current (“DC”) voltage. Circuitry 180 preferably includes circuitry controlling the shape and/or duty cycle of the generator unit output voltage (which control is altered with user switch S2). Circuitry 180 preferably also includes a pulse mode component, coupled to switch S3, to temporarily provide a burst of increased output ozone. Circuitry 180 can also include a timer circuit and a visual indicator such as a light emitting diode (“LED”). The LED or other indicator (including, if desired, audible indicator) signals when ion generation is occurring. The timer can automatically halt generation of ions and/or ozone after some predetermined time, e.g., 30 minutes. indicator(s), and/or audible indicator(s).

As shown in FIG. 3, high voltage generator unit 170 preferably comprises a low voltage oscillator circuit 190 of perhaps 20 KHz frequency, that outputs low voltage pulses to an electronic switch 200, e.g., a thyristor or the like. Switch 200 switchably couples the low voltage pulses to the input winding of a step-up transformer T1. The secondary winding of T 1 is coupled to a high voltage multiplier circuit 210 that outputs high voltage pulses. Preferably the circuitry and components comprising high voltage pulse generator 170 and circuit 180 are fabricated on a printed circuit board that is mounted within housing 102. If desired, external audio input (e.g., from a stereo tuner) could be suitably coupled to oscillator 190 to acoustically modulate the kinetic airflow produced by unit 160. The result would be an electrostatic loudspeaker, whose output air flow is audible to the human ear in accordance with the audio input signal. Further, the output air stream would still include ions and ozone.

Output pulses from high voltage generator 170 preferably are at least 10 KV peak-to-peak with an effective DC offset of perhaps half the peak-to-peak voltage, and have a frequency of perhaps 20 KHz. The pulse train output preferably has a duty cycle of perhaps 10%, which will promote battery lifetime. Of course, different peak-peak amplitudes, DC offsets, pulse train wave shapes, duty cycle, and/or repetition frequencies may instead be used. Indeed, a 100% pulse train (e.g., an essentially DC high voltage) maybe used, albeit with shorter battery lifetime. Thus, generator unit 170 may (but need not) be referred to as a high voltage pulse generator.

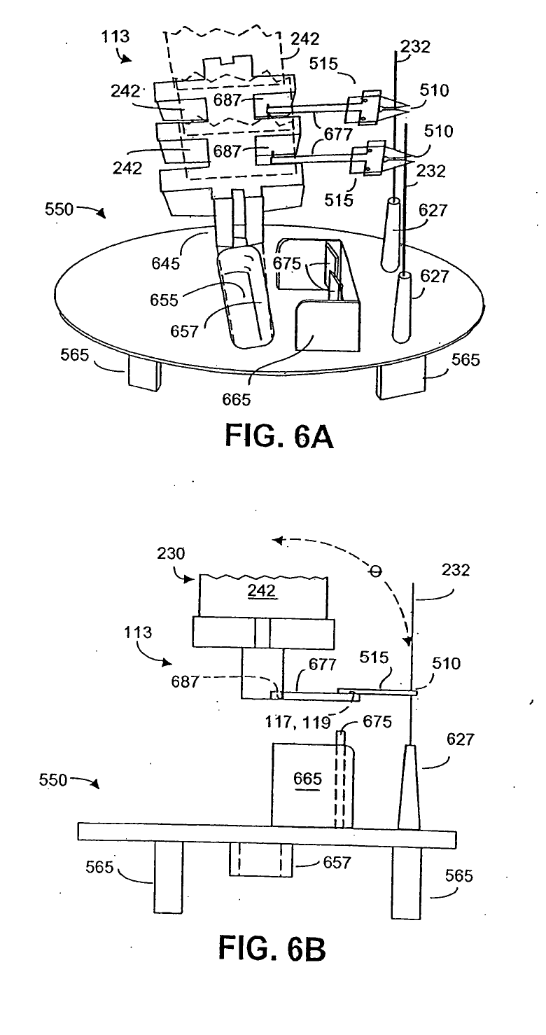

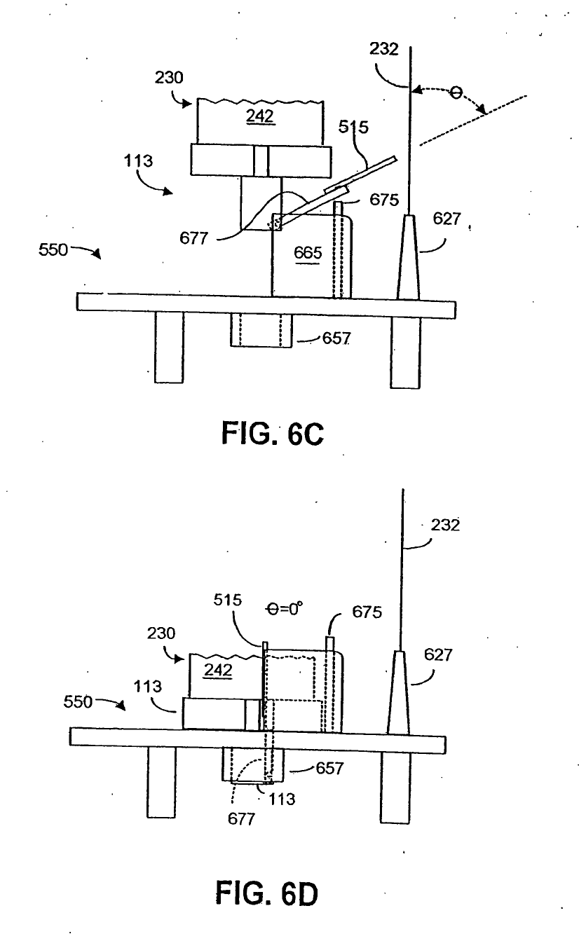

Frequency of oscillation is not especially critical but frequency of at least about 20 KHz is preferred as being inaudible to humans. If pets will be in the same room as the unit 100, it may be desired to utilize an even higher operating frequency, to prevent pet discomfort and/or howling by the pet. As noted with respect to FIGS. 5A-6E, to reduce likelihood of audible oscillations, it is desired to include at least one mechanism to clean the first electrode array 230 elements 232.

The output from high voltage pulse generator unit 170 is coupled to an electrode assembly 220 that comprises a first electrode array 230 and a second electrode array 240. Unit 170 functions as a DC:DC high voltage generator, and could be implemented using other circuitry and/or techniques to output high voltage pulses that are input to electrode assembly 220.

In the embodiment of FIG. 3, the positive output terminal of unit 170 is coupled to first electrode array 230, and the negative output terminal is coupled to second electrode array 240. This coupling polarity has been found to work well, including minimizing unwanted audible electrode vibration or hum. An electrostatic flow of air is created, going from the first electrode array towards the second electrode array. (This flow is denoted “OUT” in the figures.) Accordingly electrode assembly 220 is mounted within transporter system 100 such that second electrode array 240 is closer to the OUT vents and first electrode array 230 is closer to the IN vents.

When voltage or pulses from high voltage pulse generator 170 are coupled across first and second electrode arrays 230 and 240, it is believed that a plasma-like field is created surrounding electrodes 232 in first array 230. This electric field ionizes the ambient air between the first and second electrode arrays and establishes an “OUT” airflow that moves towards the second array. It is understood that the IN flow enters via vent(s) 104, and that the OUT flow exits via vent(s) 106.

It is believed that ozone and ions are generated simultaneously by the first array electrode(s) 232, essentially as a function of the potential from generator 170 coupled to the first array. Ozone generation maybe increased or decreased by increasing or decreasing the potential at the first array. Coupling an opposite polarity potential to the second array electrode(s) 242 essentially accelerates the motion of ions generated at the first array, producing the air flow denoted as “OUT” in the figures. As the ions move toward the second array, it is believed that they push or move air molecules toward the second array. The relative velocity of this motion maybe increased by decreasing the potential at the second array relative to the potential at the first array.

For example, if +10 KV were applied to the first array electrode(s), and no potential were applied to the second array electrode(s), a cloud of ions (whose net charge is positive) would form adjacent the first electrode array. Further, the relatively high 10 KV potential would generate substantial ozone. By coupling a relatively negative potential to the second array electrode(s), the velocity of the air mass moved by the net emitted ions increases, as momentum of the moving ions is conserved.

On the other hand, if it were desired to maintain the same effective outflow (OUT) velocity but to generate less ozone, the exemplary 10 KV potential could be divided between the electrode arrays. For example, generator 170 could provide+4 KV (or some other fraction) to the first array electrode(s) and −6 KV (or some other fraction) to the second array electrode(s). In this example, it is understood that the +4 KV and the −6 KV are measured relative to ground. Understandably it is desired that the unit 100 operate to output safe amounts of ozone. Accordingly, the high voltage is preferably fractionalized with about +4 KV applied to the first array electrode(s) and about −6 KV applied to the second array electrodes.

As noted, outflow (OUT) preferably includes safe amounts of 0₃ that can destroy or at least substantially alter bacteria, germs, and other living (or quasi-living) matter subjected to the outflow. Thus, when switch S 1 is closed and 131 has sufficient operating potential, pulses from high voltage pulse generator unit 170 create an outflow (OUT) of ionized air and 0₃. When S 1 is closed, LED will visually signal when ionization is occurring.

Preferably operating parameters of unit 100 are set during. manufacture and are not user-adjustable. For example, increasing the peak-to-peak output voltage and/or duty cycle in the high voltage pulses generated by unit 170 can increase air flow rate, ion content, and ozone content. In the preferred embodiment, output flow rate is about 200 feet/minute, ion content is about 2,000,000/cc and ozone content is about 40 ppb (over ambient) to perhaps 2,000 ppb (over ambient). Decreasing the R2/R1 ratio below about 20:1 will decrease flow rate, as will decreasing the peak-to-peak voltage and/or duty cycle of the high voltage pulses coupled between the first and second electrode arrays.

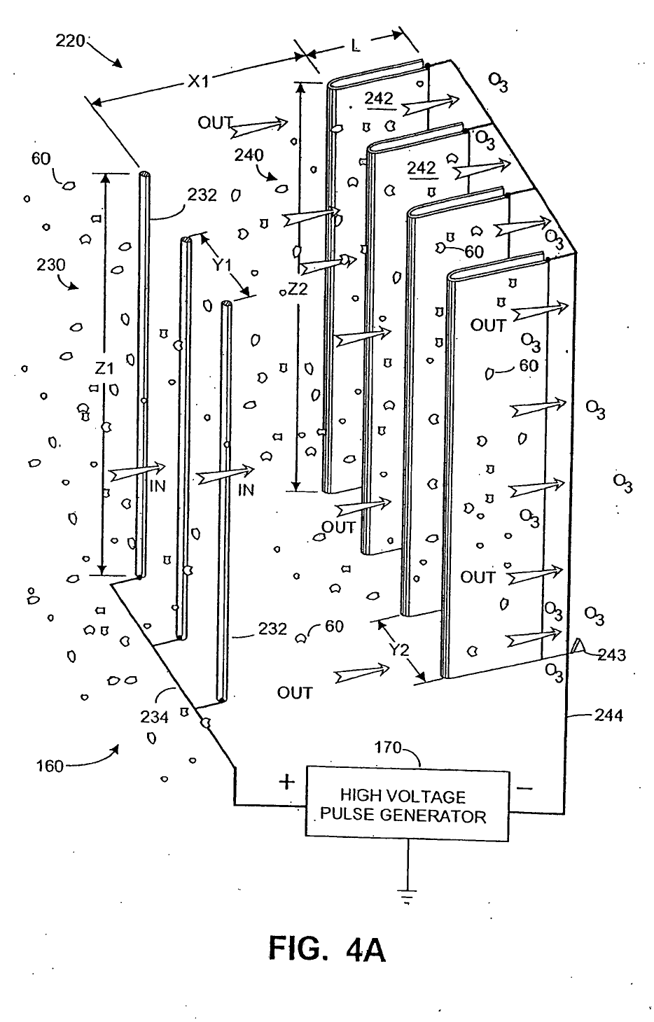

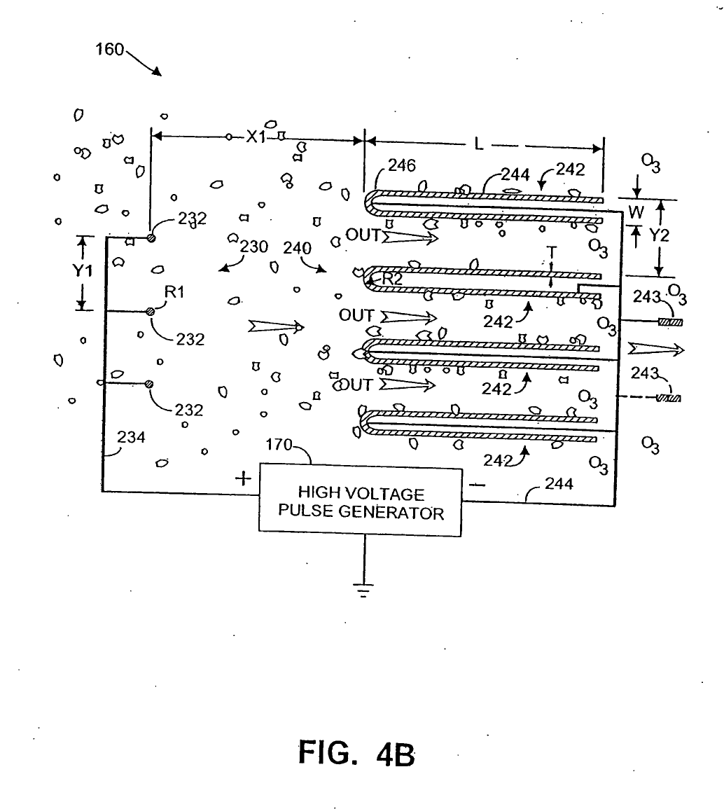

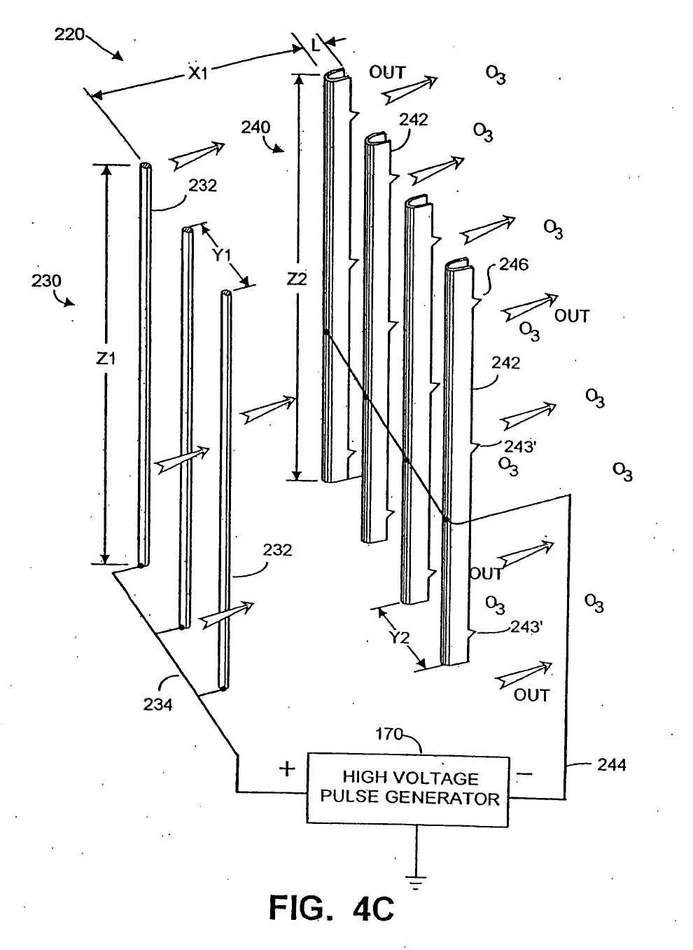

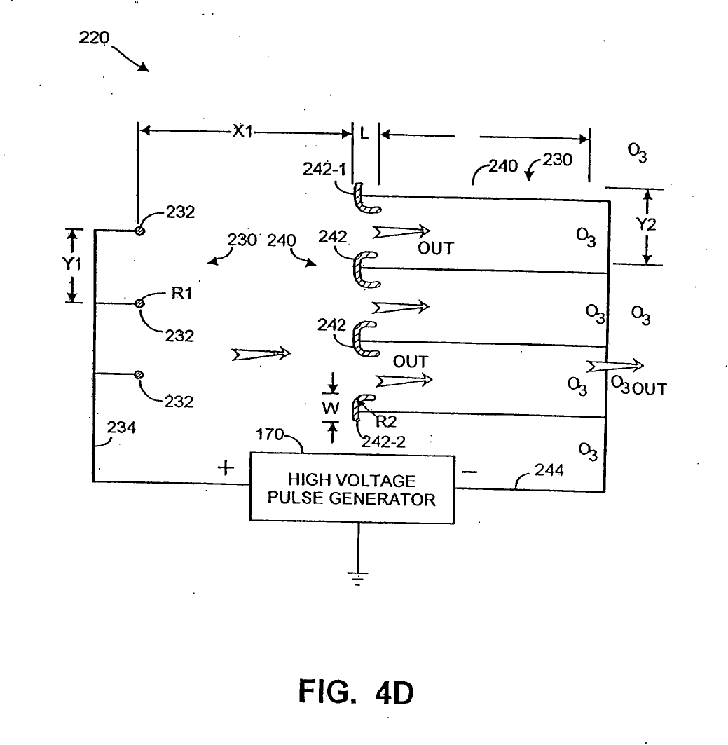

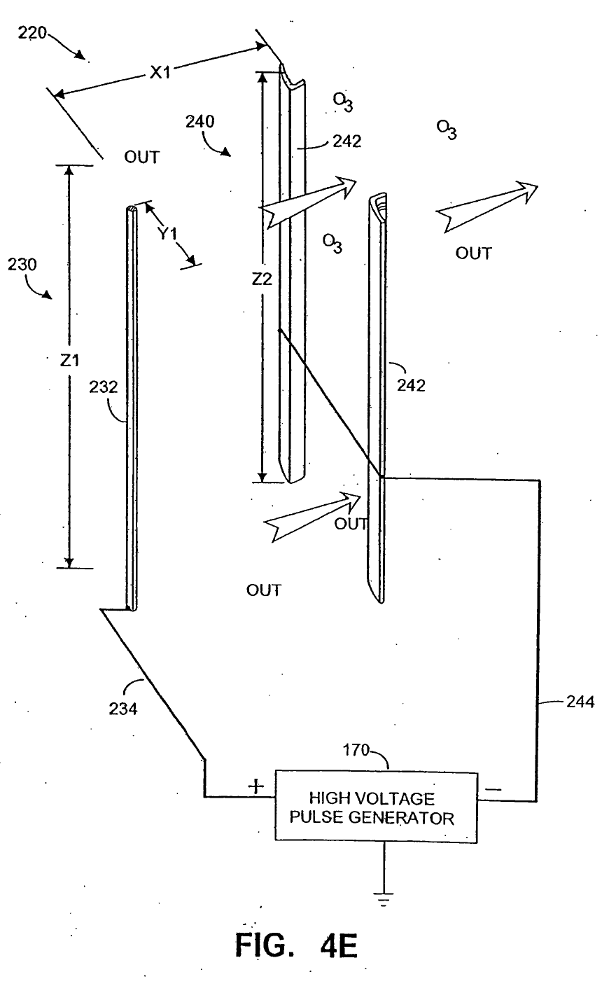

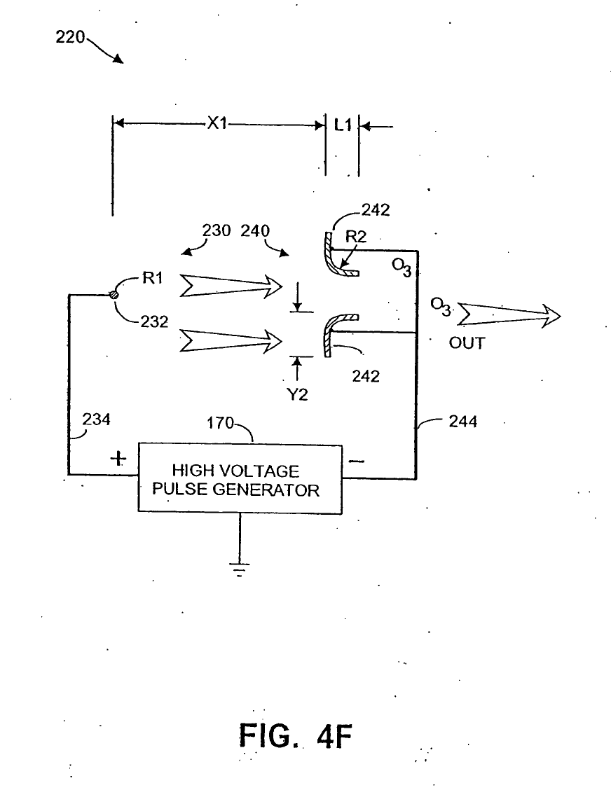

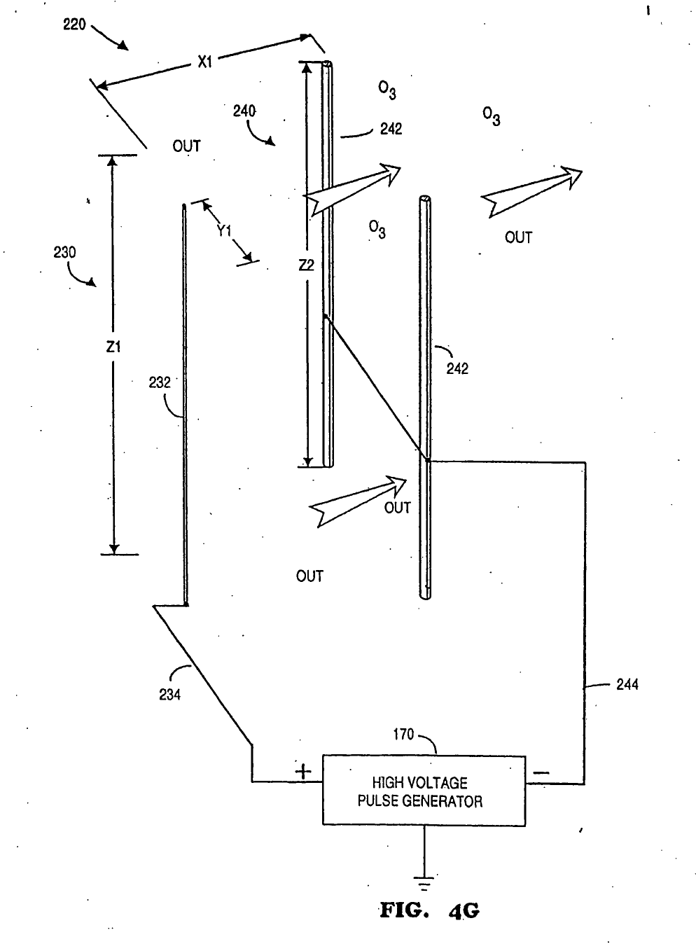

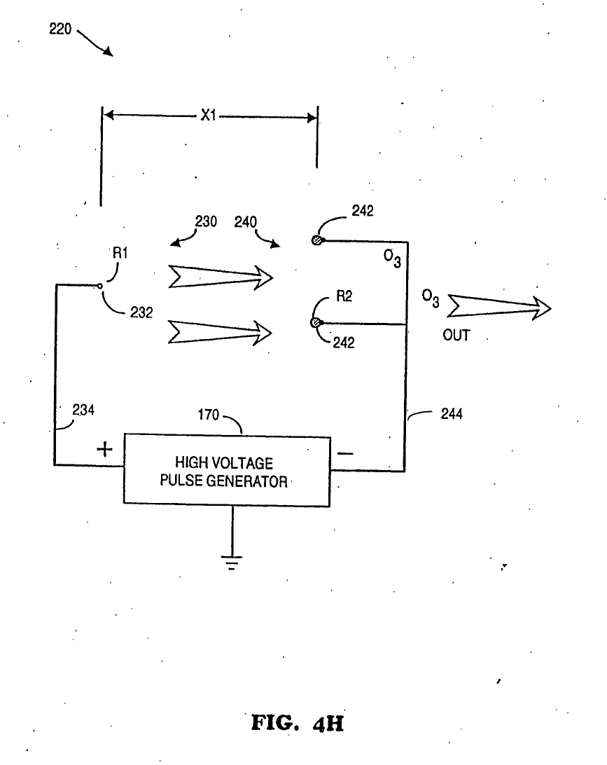

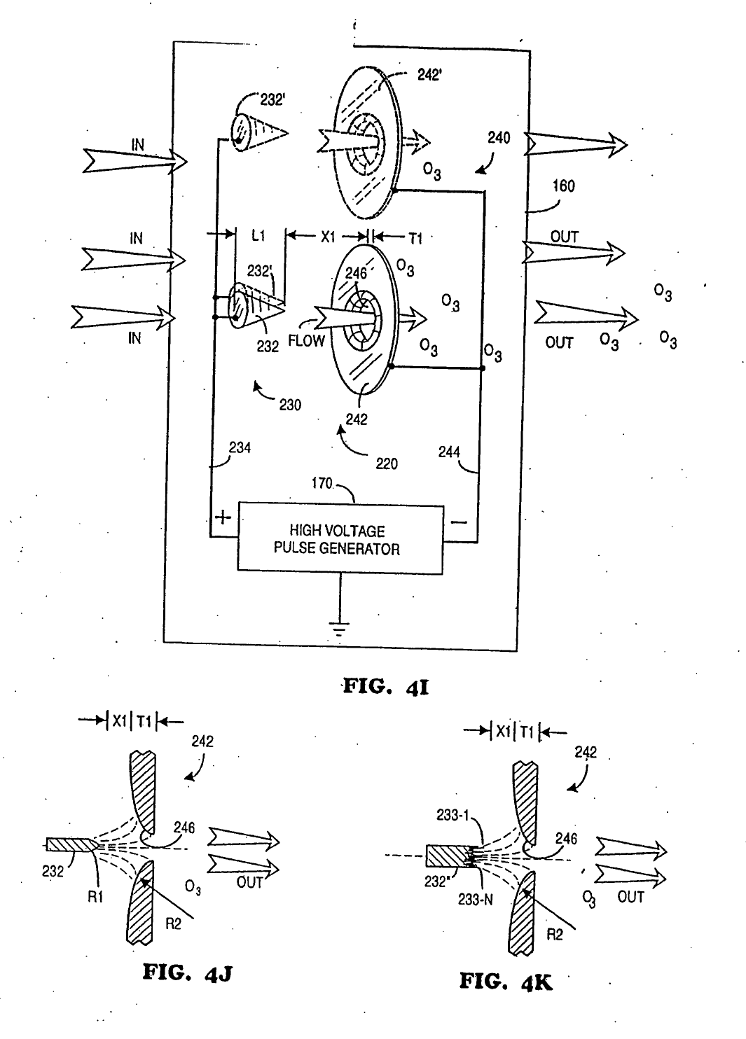

In practice, unit 100 is placed in a room and connected to an appropriate source of operating potential, typically 117 VAC. With S 1 energized, ionization unit 160 emits ionized air and preferably some ozone (0₃) via outlet vents 150. The air flow, coupled with the ions and ozone freshens the air in the room, and the ozone can beneficially destroy or at least diminish the undesired effects of certain odors, bacteria, germs, and the like. The air flow is indeed electro-kinetically produced, in that there are no intentionally moving parts within unit 100. (As noted, some mechanical vibration may occur within the electrodes.) As will be described with respect to FIG. 4A, it is desirable that unit 100 actually output a net surplus of negative ions, as these ions are deemed more beneficial to health than are positive ions.

Having described various aspects of the invention in general, preferred embodiments of electrode assembly 220 will now be described. In the various embodiments, electrode assembly 220 will comprise a first array 230 of at least one electrode 232, and will further comprise a second array 240 of preferably at least one electrode 242. Understandably material(s) for electrodes 232 and 242 should conduct electricity, be resilient to corrosive effects from the application of high voltage, yet be strong enough to be cleaned.

In the various electrode assemblies to be described herein, electrode(s) 232 in the first electrode array 230 are preferably fabricated from tungsten. Tungsten is sufficiently robust to withstand cleaning, has a high melting point to retard breakdown due to ionization, and has a rough exterior surface that seems to promote efficient ionization. On the other hand, electrodes 242 preferably will have a highly polished exterior surface to minimize unwanted point-to-point radiation. As such, electrodes 242 preferably are fabricated from stainless steel, brass, among other materials. The polished surface of electrodes 232 also promotes ease of electrode cleaning.

In contrast to the prior art electrodes disclosed by Lee, electrodes 232 and 242, electrodes used in unit 100 are light weight, easy to fabricate, and lend themselves to mass production. Further, electrodes 232 and 242 described herein promote more efficient generation of ionized air, and production of safe amounts of ozone, 0₃.

In unit 100, a high voltage pulse generator 170 is coupled between the first electrode array 230 and the second electrode array 240. The high voltage pulses produce a flow of ionized air that travels in the direction from the first array towards the second array (indicated herein by hollow arrows denoted “OUT”). As such, electrode(s) 232 maybe referred to as an emitting electrode, and electrodes 242 may be referred to as collector electrodes. This outflow advantageously contains safe amounts of 0₃, and exits unit 100 from vent(s) 106.

It is preferred that the positive output terminal or port of the high voltage pulse generator be coupled to electrodes 232, and that the negative output terminal or port be coupled to electrodes 242. It is believed that the net polarity of the emitted ions is positive, e.g., more positive ions than negative ions are emitted. In any event, the preferred electrode assembly electrical coupling minimizes audible hum from electrodes 232 contrasted with reverse polarity (e.g., interchanging the positive and negative output port connections).

However, while generation of positive ions is conducive to a relatively silent air flow, from a health standpoint, it is desired that the output air flow be richer in negative ions, not positive ions. It is noted that in some embodiments, however, one port (preferably the negative port) of the high voltage pulse generator may in fact be the ambient air. Thus, electrodes in the second array need not be connected to the high voltage pulse generator using wire. Nonetheless, there will be an “effective connection” between the second array electrodes and one output port of the high voltage pulse generator, in this instance, via ambient air.

Turning now to the embodiments of FIGS. 4A and 4B, electrode assembly 220 comprises a first array 230 of wire electrodes 232, and a second array 240 of generally “U”-shaped electrodes 242. In preferred embodiments, the number N1 of electrodes comprising the first array will preferably differ by one relative to the number N2 of electrodes comprising the second array. In many of the embodiments shown, N2>N1. However, if desired, in FIG. 4A, addition first electrodes 232 could be added at the out ends of array 230 such that N1>N2, e.g., five electrodes 232 compared to four electrodes 242.

Electrodes 232 are preferably lengths of tungsten wire, whereas electrodes 242 are formed from sheet metal, preferably stainless steel, although brass or other sheet metal could be used. The sheet metal is readily formed to define side regions 244 and bulbous nose region 246 for hollow elongated “U” shaped electrodes 242. While FIG. 4A depicts four electrodes 242 in second array 240 and three electrodes 232 in first array 230, as noted, other numbers of electrodes in each array could be used, preferably retaining a symmetrically staggered configuration as shown. It is seen in FIG. 4A that while particulate matter 60 is present in the incoming (IN) air, the outflow (OUT) air is substantially devoid of particulate matter, which adheres to the preferably large surface area provided by the second array electrodes (see FIG. 4B).

As best seen in FIG. 4B, the spaced-apart configuration between the arrays is staggered such that each first array electrode 232 is substantially equidistant from two second array electrodes 242. This symmetrical staggering has been found to be an especially efficient electrode placement. Preferably the staggering geometry is symmetrical in that adjacent electrodes 232 or adjacent electrodes 242 are spaced-apart a constant distance, Y1 and Y2 respectively. However, anon-symmetrical configuration could also be used, although ion emission and air flow would likely be diminished. Also, it is understood that the number of electrodes 232 and 242 may differ from what is shown.

In FIG. 4A, typically dimensions are as follows: diameter of electrodes 232 is about 0.08 mm, distances Y1 and Y2 are each about 16 mm, distance X1 is about 16 mm, distance L is about 20 mm, and electrode heights Z1 and Z2 are each about 1 m. The width W of electrodes 242 is preferably about 4 mm, and the thickness of the material from which electrodes 242 are formed is about 0.5 mm. Of course other dimensions and shapes could be used. It is preferred that electrodes 232 be small in diameter to help establish a desired high voltage field. On the other hand, it is desired that electrodes 232 (as well as electrodes 242) be sufficiently robust to withstand occasional cleaning.

Electrodes 232 in first array 230 are coupled by a conductor 234 to a first (preferably positive) output port of high voltage pulse generator 170, and electrodes 242 in second array 240 are coupled by a conductor 244 to a second (preferably negative) output port of generator 170. It is relatively unimportant where on the various electrodes electrical connection is made to conductors 234 or 244. Thus, by way of example FIG. 4B depicts conductor 244 making connection with some electrodes 242 internal to bulbous end 246, while other electrodes 242 make electrical connection to conductor 244 elsewhere on the electrode. Electrical connection to the various electrodes 242 could also be made on the electrode external surface providing no substantial impairment of the outflow air stream results.

To facilitate removing the electrode assembly from unit 100 (as shown in FIG. 2B), it is preferred that the lower end of the various electrodes fit against mating portions of wire or other conductors 234 or 244. For example, “cup-like” members can be affixed to wires 234 and 244 into which the free ends of the various electrodes fit when electrode array 220 is inserted completely into housing 102 of unit

The ratio of the effective electric field emanating area of electrode 232 to the nearest effective area of electrodes 242 is at least about 15:1, and preferably is at least 20:1. Thus, in the embodiment of FIG. 4A and FIG. 4B, the ratio R2/R1 2 mm/0.04 mm 50:1. [0074] In this and the other embodiments to be described herein, ionization appears to occur at the smaller electrode(s) 232 in the first electrode array 230, with ozone production occurring as a function of high voltage arcing. For example, increasing the peak-to-peak voltage amplitude and/or duty cycle of the pulses from the high voltage pulse generator 170 can increase ozone content in the output flow of ionized air. If desired, user-control S2 can be used to somewhat vary ozone content by varying (in a safe manner) amplitude and/or duty. cycle. Specific circuitry for achieving such control is known in the art and need not be described in detail herein.

Note the inclusion in FIGS. 4A and 4B of at least one output controlling electrode 243, preferably electrically coupled to the same potential as the second array electrodes. Electrode 243 preferably defines a pointed shape in side profile, e.g., a triangle. The sharp point on electrode(s) 243 causes generation of substantial negative ions (since the electrode is coupled to relatively negative high potential). These negative ions neutralize excess positive ions otherwise present in the output air flow, such that the OUT flow has a net negative charge. Electrode(s) 243 preferably are stainless steel, copper, or other conductor, and are perhaps 20 mm high and about 12 mm wide at the base.

Another advantage of including pointed electrodes 243 is that they maybe stationarily mounted within the housing of unit 100, and thus are not readily reached by human hands when cleaning the unit. Were it otherwise, the sharp point on electrode(s) 243 could easily cause cuts. The inclusion of one electrode 243 has been found sufficient to provide a sufficient number of output negative ions, but more such electrodes may be included.

In the embodiment of FIGS. 4A and 4C, each “U”-shaped electrode 242 has two trailing edges that promote efficient kinetic transport of the outflow of ionized air and 0₃. Note the inclusion on at least one portion of a trailing edge of a pointed electrode region 243′. Electrode region 243′ helps promote output of negative ions, in the same fashion as was described with respect to FIGS. 4A and 4B. Note, however, the higher likelihood of a user cutting himself or herself when wiping electrodes 242 with a cloth or the like to remove particulate matter deposited thereon. In FIG. 4C and the figures to follow, the particulate matter is omitted for ease of illustration. However, from what was shown in FIGS. 2A-4B, particulate matter will be present in the incoming air, and will be substantially absent from the outgoing air. As has been described, particulate matter 60 typically will be electrostatically precipitated upon the surface area of electrodes 242. As indicated by FIG. 4C, it is relatively unimportant where on an electrode array electrical connection is made. Thus, first array electrodes 232 are shown connected together at their bottom regions, whereas second array electrodes 242 are shown connected together in their middle regions. Both arrays may be connected together in more than one region, e.g., at the top and at the bottom. It is preferred that the wire or strips or other inter-connecting mechanisms be at the top or bottom or periphery of the second array electrodes 242, so as to minimize obstructing stream air movement.

Note that the embodiments of FIGS. 4C and 4D depict somewhat truncated versions of electrodes 242. Whereas dimension L in the embodiment of FIGS. 4A and 4B was about 20 mm, in FIGS. 4C and 4D, L has been shortened to about 8 mm. Other dimensions in FIG. 4C preferably are similar to those stated for FIGS. 4A and 4B. In FIGS. 4C and 4D, the inclusion of point-like regions 246 on the trailing edge of electrodes 242 seems to promote more efficient generation of ionized air flow. It will be appreciated that the configuration of second electrode array 240 in FIG. 4C can be more robust than the configuration of FIGS. 4A and 4B, by virtue of the shorter trailing edge geometry. As noted earlier, a symmetrical staggered geometry for the first and second electrode arrays is preferred for the configuration of FIG. 4C.

In the embodiment of FIG. 4D, the outermost second electrodes, denoted 242-1 and 242-2, have substantially no outermost trailing edges. Dimension L in FIG. 4D is preferably about 3 mm, and other dimensions may be as stated for the configuration of FIGS. 4A and 4B. Again, the R2/R1 ratio for the embodiment of FIG. 4D preferably exceeds about 20:1

FIGS. 4E and 4F depict another embodiment of electrode assembly 220, in which the first electrode array comprises a single wire electrode 232, and the second electrode array comprises a single pair of curved “L”-shaped electrodes 242, in cross-section. Typical dimensions, where different than what has been stated for earlier-described embodiments, are X1 12 mm, Y1 6 mm, Y2.5 mm, and L 1 z, 3 mm. The effective R2/R1 ratio is again greater than about 20:1. The fewer electrodes comprising assembly 220 in FIGS. 4E and 4F promote economy of construction, and ease of cleaning, although more than one electrode 232, and more than two electrodes 242 could of course be employed. This embodiment again incorporates the staggered symmetry described earlier, in which electrode 232 is equidistant from two electrodes 242.

FIGS. 4G and 4H shown yet another embodiment for electrode assembly 220. In this embodiment, first electrode array 230 is a length of wire 232, while the second electrode array 240 comprises a pair of rod or columnar electrodes 242. As in embodiments described earlier herein, it is preferred that electrode 232 be symmetrically equidistant from electrodes 242. Wire electrode 232 is preferably perhaps 0.08 mm tungsten, whereas columnar electrodes 242 are perhaps 2 mm diameter stainless steel. Thus, in this 35 embodiment the R2/R1 ratio is about 25:1. Other dimensions may be similar to other configurations, e.g., FIGS. 4E, 4F. Of course electrode assembly 220 may comprise more than one electrode 232, and more than two electrodes 242.

An especially preferred embodiment is shown in FIG. 4I and FIG. 4J. In these figures, the first electrode assembly comprises a single pin-like element 232 disposed coaxially with a second electrode array that comprises a single ring-like electrode 242 having a rounded inner opening 246. However, as indicated by phantom elements 232′, 242′, electrode assembly 220 may comprise a plurality of such pin-like and ring-like elements. Preferably electrode 232 is tungsten, and electrode 242 is stainless steel.

Typical dimensions for the embodiment of FIG. 4I and FIG. 4J are L1 10 mm, X1 9.5 mm, T 0.5 mm, and the diameter of opening 246 is about 12 mm. Dimension L1 preferably is sufficiently long that upstream portions of electrode 232 (e.g., portions to the left in FIG. 4I do not interfere with the electrical field between electrode 232 and the collector electrode 242. However, as shown in FIG. 4J, the effect R2/R1 ratio is governed by the tip geometry of electrode 232. Again, in the preferred embodiment, this ratio exceeds about 20:1. Lines drawn in phantom in FIG. 4J depict theoretical electric force field lines, emanating from emitter electrode 232, and terminating on the curved surface of collector electrode 246. Preferably the bulk of the field emanates within about ±45′ of coaxial axis between electrode 232 and electrode 242. On the other hand, if the opening in electrode 242 and/or electrode 232 and 242 geometry is such that too narrow an angle about the coaxial axis exists, air flow will be unduly restricted.

One advantage of the ring-pin electrode assembly configuration shown in FIG. 41 is that the flat regions of ring-like electrode 242 provide sufficient surface area to which particulate matter 60 entrained in the moving air stream can attach, yet be readily cleaned.

Further, the ring-pin configuration advantageously generates more ozone than prior art configurations, or the configurations of FIGS. 4A-4H. For example, whereas the configurations of FIGS. 4A-4H may generate perhaps 50 ppb ozone, the configuration of FIG. 4I can generate about 2,000 ppb ozone.

Nonetheless it will be appreciated that applicants' first array pin electrodes may be utilized with the second array electrodes of FIGS. 4A-4H. Further, applicants' second array ring electrodes may be utilized with the first array electrodes of FIGS. 4A-4H. For example, in modifications of the embodiments of FIGS. 4A-4H, each wire or columnar electrode 232 is replaced by a column of electrically series-connected pin electrodes (e.g., as shown in FIGS. 4I-4K), while retaining the second electrode arrays as depicted in these figures. By the same token, in other modifications of the embodiments of FIGS. 4A-4H, the first array electrodes can remain as depicted, but each of the second array electrodes 242 is replaced by a column of electrically series-connected ring electrodes (e.g., as shown in FIGS. 4I-4K).

In FIG. 4J, a detailed cross-sectional view of the central portion of electrode 242 in FIG. 4I is shown. As best seen in FIG. 4J, curved region 246 adjacent the 30 central opening in electrode 242 appears to provide an acceptably large surface area to which many ionization paths from the distal tip of electrode 232 have substantially equal path length. Thus, while the distal tip (or emitting tip) of electrode 232 is advantageously 35 small to concentrate the electric field between the electrode arrays, the adjacent regions of electrode 242 preferably provide many equidistant inter-electrode array paths. A high exit flow rate of perhaps 90 feet/minute and 2,000 ppb range ozone emission attainable with this configuration confirm a high operating efficiency.

In FIG. 4K, one or more electrodes 232 is replaced by a conductive block 232″ of carbon fibers, the block having a distal surface in which projecting fibers 233-1, . . . 233-N take on the appearance of a “bed of nails”. The projecting fibers can each act as an emitting electrode and provide a plurality of emitting surfaces. Over a period of time, some or all of the electrodes will literally be consumed, whereupon graphite block 232″ will be replaced. Materials other than graphite may be used for block 232″ providing the material has a surface with projecting conductive fibers such as 233-N.

As described, the net output of ions is influenced by placing a bias element (e.g., element 243) near the output stream and preferably near the downstream side of the second array electrodes. If no ion output were desired, such an element could achieve substantial neutralization. It will also be appreciated that the present invention could be adjusted to produce ions without producing ozone, if desired.

Turning now to FIG. 5A, a first embodiment of an electrode cleaning mechanism 500 is depicted. In the embodiment shown, mechanism 500 comprises a flexible sheet of insulating material such as MYLAR or other high voltage, high temperature breakdown resistant material, having sheet thickness of perhaps 0.1 mm or so. Sheet 500 is attached at one end to the base or other mechanism 113 secured to the lower end of second electrode array 240. Sheet 500 extends or projects out from base 113 towards and beyond the location of first electrode array 230 electrodes 232. The overall projection length of sheet 500 in FIG. 5A will be sufficiently long to span the distance between base 113 of the second array 240 and the location of electrodes 232 in the first array 230. This span distance will depend upon the electrode array configuration but typically will be a few inches or so. Preferably the distal edge of sheet 500 will extend slightly beyond the location of electrodes 232, perhaps 0.5″ beyond. As shown in FIGS. 5A and 5C, the distal edge, e.g., edge closest to electrodes 232, of material 500 is formed with a slot 510 corresponding to the location of an electrode 232. Preferably the inward end of the slot forms a small circle 520, which can promote flexibility.

The configuration of material 500 and slots 510 is such that each wire or wire-like electrode 232 in the first electrode array 230 fits snugly and friction ally within a corresponding slot 510. As indicated by FIG. 5A and shown in FIG. 5C, instead of a single sheet 500 that includes a plurality of slots 510, instead one can provide individual strips 515 of material 500, the distal end of each strip having a slot 510 that will surround an associated wire electrode 232. Note in FIGS. 5B and 5C that sheet 500 or sheets 515 maybe formed with holes 119 that can attach to pegs 117 that project from the base portion 113 of the second electrode array 240. Of course other attachment mechanisms could be used including glue, double-sided tape, inserting the array 240—facing edge of the sheet into a horizontal slot or ledge in base member 113, and so forth.

The configuration of material 500 and slots 510 is such that each wire or wire-like electrode 232 in the first electrode array 230 fits snugly and friction ally within a corresponding slot 510. As indicated by FIG. 5A and shown in FIG. 5C, instead of a single sheet 500 that includes a plurality of slots 510, instead one can provide individual strips 515 of material 500, the distal end of each strip having a slot 510 that will surround an associated wire electrode 232. Note in FIGS. 5B and 5C that sheet 500 or sheets 515 maybe formed with holes 119 that can attach to pegs 117 that project from the base portion 113 of the second electrode array 240. Of course other attachment mechanisms could be used including glue, double-sided tape, inserting the array 240—facing edge of the sheet into a horizontal slot or ledge in base member 113, and so forth.

FIG. 5A shows second electrode array 240 in the process of being moved upward, perhaps by a user intending to remove array 240 to remove particulate matter from the surfaces of its electrodes 242. Note that as array 240 moves up (or down), sheet 500 (or sheets 515) also move up (or down). This vertical movement of array 240 produces a vertical movement in sheet 500 or 515, which causes the outer surface of electrodes 232 to scrape against the inner surfaces of an associated slot 510. FIG. 5A, for example, shows debris and other deposits 612 (indicated by x's) on wires 232 above sheet 500. As array 240 and sheet 500 move upward, debris 612 is scraped off the wire electrodes, and falls downward (to be vaporized or collected as particulate matter when unit 100 is again reassembled and turned-on). Thus, the outer surface of electrodes 232 below sheet 500 in FIG. 5A is shown as being cleaner than the surface of the same electrodes above sheet 500, where scraping action has yet to occur.

A user hearing that excess noise or humming emanates from unit 100 might simply turn the unit off, and slide array 240 (and thus sheet 500 or sheets 515) up and down (as indicated by the up/down arrows in FIG. 5A) to scrape the wire electrodes in the first electrode array. This technique does not damage the wire electrodes, and allows the user to clean as required.

As noted earlier, a user may remove second electrode array 240 for cleaning (thus also removing sheet 500, which will have scraped electrodes 232 on its upward vertical path). If the user cleans electrodes 242 with water and returns array 240 to unit 100 without first completely drying 240, moisture might form on the upper surface of a horizontally disposed member 550 within unit 100. Thus, as shown in FIG. 5B, it is preferred that an upwardly projecting vane 560 be disposed near the base of each electrode 232 such that when array 240 is fully inserted into unit 100, the distal portion of sheet 500 or preferably sheet strips 515 deflect upward. While sheet 500 or sheets 515 nominally will define an angle 0 of about 90°, as base 113 becomes fully inserted into unit 100, the angle 0 will increase, approaching 0°, e.g., the sheet is extending almost vertically upward. If desired, a portion of sheet 500 or sheet strips 515 can be made stiffer by laminating two or more layers of MYLAR or other material. For example the distal tip of strip 515 in FIG. 5B might be one layer thick, whereas the half or so of the strip length nearest electrode 242 might be stiffened with an extra layer or two of MYLAR or similar material.

The inclusion of a projecting vane 560 in the configuration of FIG. 5B advantageously disrupted physical contact between sheet 500 or sheet strips 515 and electrodes 232, thus tending to preserve a high ohmic impedance between the first and second electrode arrays 230, 240. The embodiment of FIGS. 6A-6D advantageously serves to pivot sheet 500 or sheet strips 515 upward, essentially parallel to electrodes 232, to help maintain a high impedance between the first and second electrode arrays. Note the creation of an air gap 513 resulting from the upward deflection of the slit distal tip of strip 515 in FIG. 5B.

In FIG. 6A, the lower edges of second array electrodes 242 are retained by a base member 113 from which project arms 677, which can pivot about pivot axle 687. Preferably axle 687 biases arms 677 into a horizontal disposition, e.g., such that 0 90°. Arms 645 project from the longitudinal axis of base member 113 to help member 113 align itself within an opening 655 formed in member 550, described below. Preferably base member 113 and arms 677 are formed from a material that exhibits high voltage breakdown and can withstand high temperature. Ceramic is a preferred material (if cost and weight were not considered), but certain plastics could also be used. The unattached tip of each arm 677 terminates in a sheet strip 515 of MYLAR, KAPTON, or a similar material, whose distal tip terminates in a slot 510. It is seen that the pivotable arms 677 and sheet strips 515 are disposed such that each slot 510 will self-align with a wire or wire-like electrode 232 in first array 230. Electrodes 232 preferably extend from pylons 627 on a base member 550 that extends from legs 565 from the internal bottom of the housing of the transporter-conditioner unit. To further help maintain high impedance between the first and second electrode arrays, base member 550 preferably includes a barrier wall 665 and upwardly extending vanes 675. Vanes 675, pylons 627, and barrier wall 665 extend upward perhaps an inch or so, depending upon the configuration of the two electrode be formed integrally, e.g., by casting, from a material that exhibits high voltage breakdown and can withstand high temperature, ceramic, or certain plastics for example.

As best seen in FIG. 6A, base member 550 includes an opening 655 sized to receive the lower portion of second electrode array base member 113. In FIGS. 6A and 6B, arms 677 and sheet material 515 are shown pivoting from base member 113 about axis 687 at an angle 9 90°. In this disposition, an electrode 232 will be within the slot 510 formed at the distal tip of each sheet material member 515.

Assume that a user had removed second electrode array 240 completely from the transporter-conditioner unit for cleaning, and that FIGS. 6A and 6B depict array 240 being reinserted into the unit. The coiled spring or other bias mechanism associated with pivot axle 687 will urge arms 677 into an approximate 0 90° orientation as the user inserts array 240 into unit 100. Side projections 645 help base member 113 align properly such that each wire or wire-like electrode 232 is caught within the slot 510 of a member 515 on an arm 677. As the user slides array 240 down into unit 100, there will be a scraping action between the portions of sheet member 515 on either side of a slot 510, and the outer surface of an electrode 232 that is essentially captured within the slot. This friction will help remove debris or deposits that may have formed on the surface of electrodes 232. The user may slide array 240 up and down the further promote the removal of debris or deposits from elements 232.

In FIG. 6C the user has slid array 240 down almost entirely into unit 100. In the embodiment shown, when the lowest portion of base member 232 is perhaps an inch or so above the planar surface of in member 550, the upward edge of a vane 675 will strike the a lower surface region of a projection arm 677. The result will be to pivot arm 677 and the attached slit-member 515 about axle 687 such that the angle 0 decreases. In the disposition shown in FIG. 6C, 0^{z} 45° and slit contact with an associated electrode 232 is no longer made.

In FIG. 6D, the user has firmly urged array 240 fully downward into transporter conditioner unit 100. In this disposition, as the projecting bottommost portion of member 113 begins to enter opening 655 in member 550 (see FIG. 6A), contact between the inner wall 657 portion of member 550 urges each arm 677 to pivot fully upward, e.g., 0 0°. Thus in the fully inserted disposition shown in FIG. 6D, each slit electrode cleaning member 515 is rotated upward parallel to its associated electrode 232. As such, neither arm 677 nor member 515 will decrease impedance between first and second electrode arrays 230, 240. Further, the presence of vanes 675 and barrier wall 665 further promote high impedance.

Thus, the embodiments shown in FIGS. 5A-6D depict alternative configurations for a cleaning mechanism for a wire or wire-like electrode in a transporter conditioner unit.

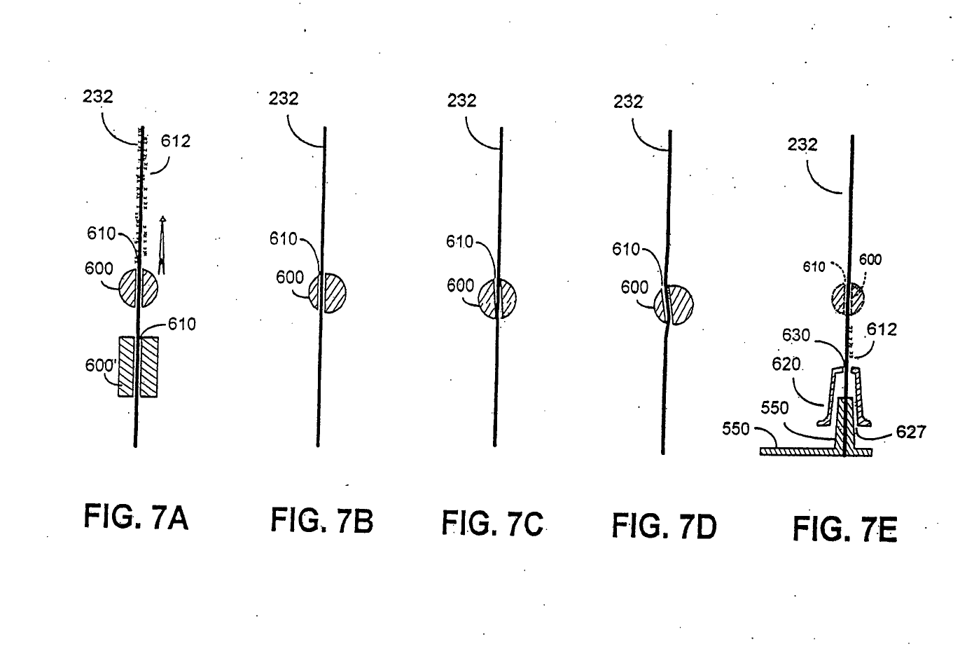

Turning now to FIGS. 7A-7E, various bead-like mechanisms are shown for cleaning deposits from the outer surface of wire electrodes 232 in a first electrode array 230 in a transporter-converter unit. h1 FIG. 7A a symmetrical bead 600 is shown surrounding wire element 232, which is passed through bead channel 610 at the time the first electrode array is fabricated. Bead 600 is fabricated from a material that can withstand high temperature and high voltage, and is not likely to char, ceramic or glass, for example. While a metal bead would also work, an electrically conductive bead material would tend slightly to decrease the resistance path separating the first and second electrode arrays, e.g., by approximately the radius of the metal bead. In FIG. 7A, debris and deposits 612 on electrode 232 are depicted as “x's”. In FIG. 7A, bead 600 is moving in the direction shown by the arrow relative to wire 232. Such movement can result from the user inverting unit 100, e.g., turning the unit upside down. As bead 600 slides in the direction of the arrow, debris and deposits 612 scrape against the interior walls of channel 610 and are removed. The removed debris can eventually collect at the bottom interior of the transporter-conditioner unit. Such debris will be broken down and vaporized as the unit is used, or will accumulate as particulate matter on the surface of electrodes 242. If wire 232 has a nominal diameter of say 0.1 mm, the diameter of bead channel 610 will be several times larger, perhaps 0.8 mm or so, although greater or lesser size tolerances maybe used. Bead 600 need not be circular and may instead be cylindrical as shown by bead 600′ in FIG. 7A. A circular bead may have a diameter in the range of perhaps 0.3″ to perhaps 0.5″. A cylindrical bead might have a diameter of say 0.3″ and be about 0.5″ tall, although different sizes could of course be used.

As indicated by FIG. 7A, an electrode 232 maybe strung through more than one bead 600, 600′. Further, as shown by FIGS. 7B-7D, beads having different channel symmetries and orientations maybe used as well. It is to be noted that while it maybe most convenient to form channels 610 with circular cross-sections, the cross-sections could in fact be non-circular, e.g., triangular, square, irregular shape, etc.

FIG. 7B shows a bead 600 similar to that of FIG. 7A, but wherein channel 610 is formed off-center to give asymmetry to the bead. An off-center channel will have a mechanical moment and will tend to slightly tension wire electrode 232 as the bead slides up or down, and can improve cleaning characteristics. For ease of illustration, FIGS. 7B-7E do not depict debris or deposits on or removed from wire or wire-like electrode 232. In the embodiment of FIG. 7C, bead channel 610 is substantially in the center of bead 600 but is inclined slightly, again to impart a different frictional cleaning action. In the embodiment of FIG. 7D, beam 600 has a channel 610 that is both off center and inclined, again to impart a different frictional cleaning action. In general, asymmetrical bead channel or through-opening orientations are preferred.

FIG. 7E depicts an embodiment in which a bell-shaped walled bead 620 is shaped and sized to fit over a pillar 550 connected to a horizontal portion 560 of an interior bottom portion of unit 100. Pillar 550 retains the lower end of wire or wire-like electrode 232, which passes through a channel 630 in bead 620, and if desired, also through a channel 610 in another bead 600. Bead 600 is shown in phantom in FIG. 7E to indicate that it is optional.

Friction between debris 612 on electrode 232 and the mouth of channel 630 will tend to remove the debris from the electrode as bead 620 slides up and down the length of the electrode, e.g., when a user inverts transporter-conditioner unit 100, to clean electrodes 232. It is understood that each electrode 232 will include its own bead or beads, and some of the beads may have symmetrically disposed channels, while other beads may have asymmetrically disposed channels. An advantage of the configuration shown in FIG. 7E is that when unit 100 is in use, e.g., when bead 620 surrounds pillar 550, with an air gap there between, improved breakdown resistance is provided, especially when bead 620 is fabricated from glass or ceramic or other high voltage, high temperature breakdown material that will not readily char. The presence of an air gap between the outer surface of pillar 550 and the inner surface of the bell shaped bead 620 helps increase this resistance to high voltage breakdown or arcing, and to charring.

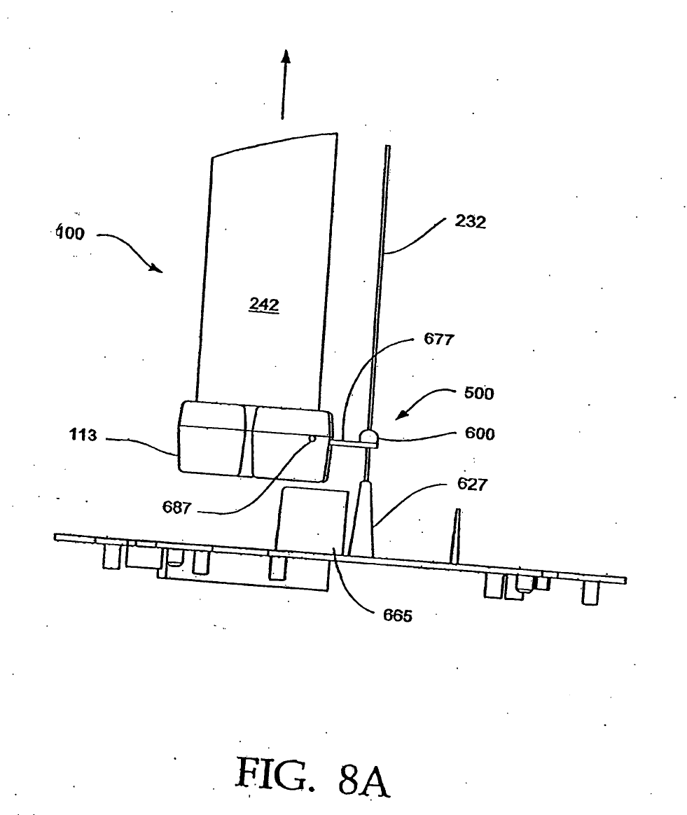

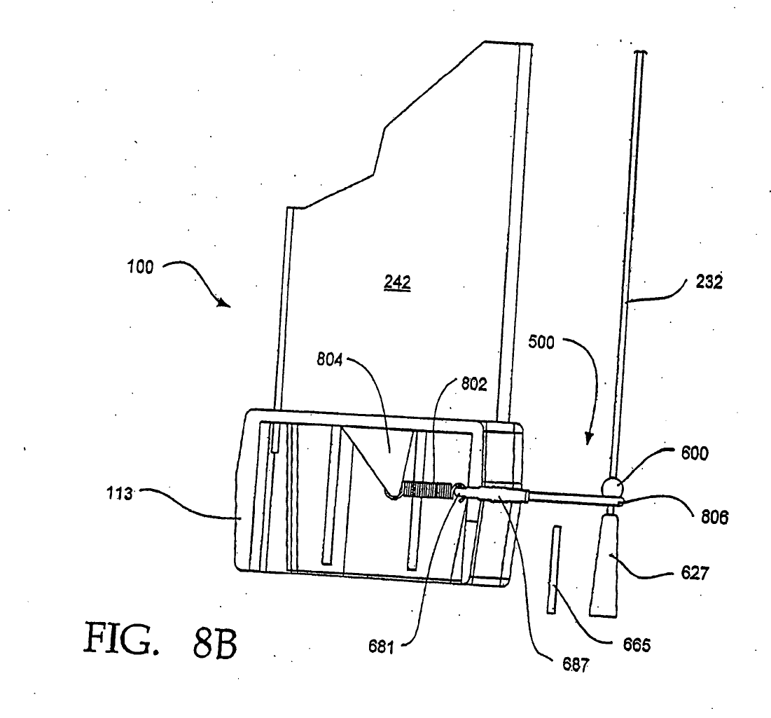

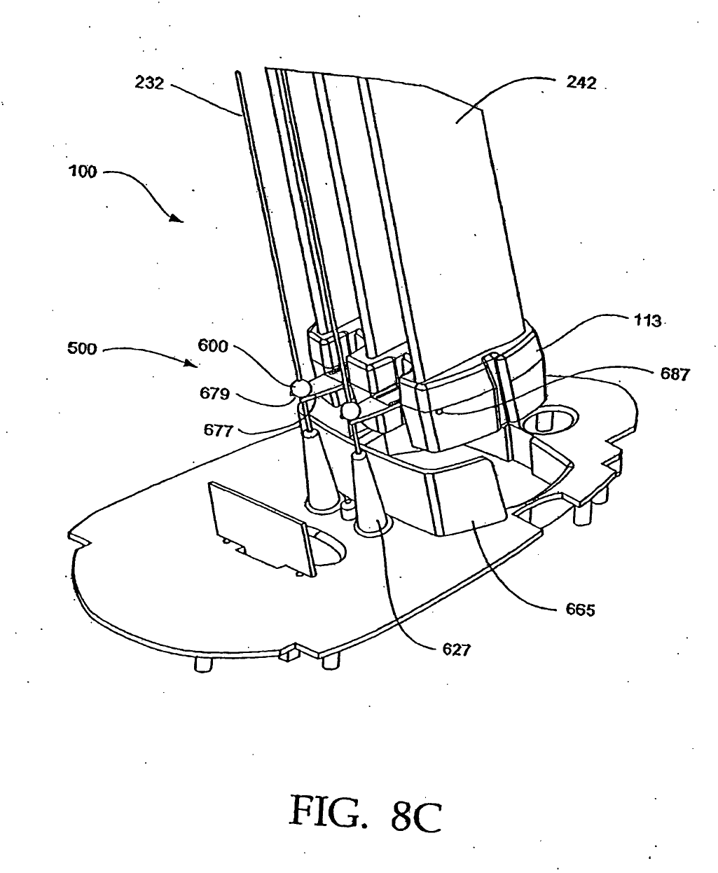

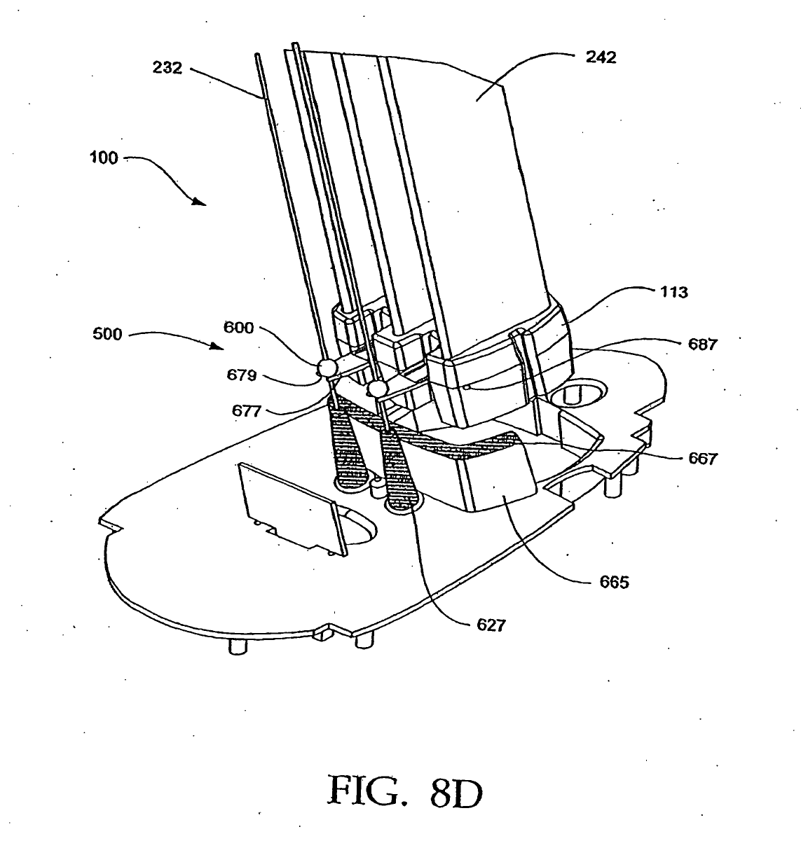

Turning now to another embodiment of the invention, in FIG. 8A, a side view of a cleaning mechanism 500 is depicted. Cleaning mechanism 500 in this preferred embodiment includes projecting, bead lifting arms 677 extending from the longitudinal axis of collector electrode base 113 into a horizontal disposition. Bead lifting arms 677 include a distal end 679 which is fork-shaped, having two prongs that extend on each side of an emitter or first electrode 232 (FIG. 8C). Unlike other embodiments, the two prongs of distal end 679 do not engage the electrode 232 as the cleaning is accomplished with the bead 600 as described below. Preferably the bead lifting arm 677 is comprised of an insulating material or other high voltage, high temperature breakdown resistant material. For example ABS plastic can be used to construct bead lifting arm 677.

In the preferred embodiment, the bead lifting arm 677 is configured so that the arm sits below bead 600 with the collector electrode 242 fully seated in the unit 100 as shown in FIG. 8B. When the electrodes 242 are removed from the unit 100, the bead lifting arm 677 lifts the bead 600 upward, away from pylons or electrode bottom end stop 627 along the length of electrodes 232. It will be appreciated by those of skill in the art that the bead 600 depicted in this figure may take on a variety of shapes and configurations without departing from the scope of the invention. For example, the bead 600 may take on the various configurations as shown in FIG. 7 with respect to orientation of the bore. Similarly, with respect to shape, the bead bore can be spherical, hemispherical, square, rectangular or a variety of other shapes without departing from the scope of the invention as previously discussed. Further, the bead 600 can be comprised of a variety of materials as previously described.

Turning now to FIG. 8B electrode 242 is shown seated in the unit 100. In this embodiment, the bead lifting arm 677 is pivotally mounted to the base 113 of the collectors 242 at pivot axis 687. The end 681 of the bead lifting arm 622 has a spring 802 attached thereto. The other end of spring 802 is attached to a bracket 804 which projects below the collector electrodes 242. Accordingly the bead lifting arm 677 is capable of deflecting when the electrode 242 is removed from the housing 102. The spring 802 has enough stiffness to allow the lifting of the bead 600 along the surface of the electrode 232, when the electrode 242 is removed from the housing 102. As will be appreciated by those of skill in the art, the bead need not be lifted the entire length of the electrode 242, but should be lifted along a length of the electrode 242 sufficient to enable the electrode to function as designed.

The embodiment of the invention depicted in FIGS. 8A, 8B, 8C and 8D operates as follows. With the electrodes 242 in the down or operating position, the base 113 of the electrodes 242 seats behind the barrier wall 665 as shown in FIG. 8B. In order to reach this position, the bead lifting arm 677 pivots about pivot point 687 as they are deflected around the bead 600 in order to be positioned below the bead 600 as shown in FIGS. 8A and 8B. Once the lifting arm 677 has been deflected so that it is urged around and below bead 600, the lifting arm 677 snaps back into the horizontal position as shown in FIGS. 8A and 8B, below and ready to lift the bead 600.

When it is desired to clean the electrodes, the collector electrodes 242 are lifted from the housing. As this is accomplished, the bead lifting arm 677 lifts the bead 600 from the position shown in FIGS. 8A and 8B, to the top of the emitter electrodes 232, thereby cleaning the emitter electrodes as the beads are lifted. Once the beads are lifted to the top of the emitter electrodes 232, the lifting arm 677 is deflected around the beads 600 as the bead lifting arm 677 around pivot point 687. As this occurs, the bead 600 falls away from the lifting arm 677 as the collector electrodes 242 are completely removed from the housing. The bead then drop to the base of the emitter electrode 232 and come in contact with the pylon 627 where the bead rest until the bead again engage with the bead lifting arm 677. After the electrodes 242 are cleaned, as for example by wiping them with a cloth, the electrodes 242 are reinserted into the housing with the base 113 of the electrodes 242 once again coming into proximity of the barrier wall 665. As this occurs, the bead lifting arms 677 are again deflected about the bead 600 so that they come into the position between the bead 600 and the pylon 627, ready again to lift the bead 600 upwardly as and when the collector electrodes 242 are again removed upwardly from the housing in order to clean the electrodes. It is to be understood that the bead 600 operate to clean the emitter electrodes in much the same way as beads 600 operate in FIGS. 7A-7E.

In alternative embodiment, the lifting arms 677 themselves actually engage and clean the emitter electrodes 232 as described in the other embodiments. In this arrangement, the lifting arm 677 can also be configured much as the distal end of the arm 677 in FIG. 6A as well as the distal end of the strip 515 in FIG. 5C. In these embodiments, the distal end of the arm 677 engages and cleans the emitter electrode 232 as well as lifts the bead which also cleans the emitter electrode. Also in these alternative embodiments, the arm must be sufficiently stiff so that as well as cleaning the electrode, the arm also is able to lift the weight of the beads 600.

In another alternative embodiment, the air cleaning unit includes a germicidal UV light source to rid the air of mold, bacteria, and viruses. The Lw light can attract insects. When an insect approaches the UV light source, it can fly between the emitter and collector electrodes. The insect may short circuit the electrodes and cause high voltage arcing. The debris from the insect's body can fall toward the bottom of the housing and can also deposit between the emitter and collector electrodes, resulting in a carbon path between the emitter and collector electrodes.

A preferred embodiment depicted in FIG. 8D insulates key elements to inhibit arcing due to insect remains. The main elements are (1) the pylons 627 that secure the emitter electrodes 232 to the base, (2) the barrier wall, 665 which is located in between the emitter 232 and collector electrodes 242 and adjacent to the collector electrodes, or the lip 667 on the upper edge of the barrier wall, and (3) the beads 600 used for cleaning the emitter electrodes. Insulating materials can include glass, ceramic materials, or both in any combination, with any combination of the key elements. Preferably, the bead 600, the pylons 627, the barrier wall 665, and/or the lip 667 are comprised of glass. The insulation material in addition to glass or a ceramic can include ceramic based composites. Such ceramics can include, by way of example only, ceramic oxides such as, by way of example only, ABS plastics, and preferably a high temperature ABS plastic. Casting or coating of the elements listed above with insulating material are both contemplated as being within the scope of the present invention. It is to be understood that if coating is used to insulate, then a plastic material suitable for consumer electronics will be underneath the insulating coating. Such plastic material could include, by way of example, an engineering plastic. Accordingly, the embodiment of the present invention provides an insulating barrier between the emitter electrodes and the collector electrodes in order to interrupt any potential carbon path which could have been caused by the destroyed insects.

The purpose of emitter electrodes (e.g., wire-shaped electrodes), of electro-kinetic air transporter and conditioner systems, is to produce a corona discharge that ionizes (i.e., charges) the particles in the air in the vicinity of the emitter electrodes. Collector electrodes, which typically have an opposite charge as the emitter electrodes, will attract the charged particles to cause the charged particles to collect on the collector electrodes, thereby cleaning the air. The collector electrodes preferably can be removed vertically from a housing (containing the electrodes), manually cleaned, and then returned to the housing. Although the collector electrodes are typically in need of cleaning more often then the emitter electrodes, the emitter electrodes can eventually accumulate a deposited layer or coating of fine ash-like material. Additionally, dendrites present in the air may accumulate on the emitter electrodes. If such deposits (also referred to hereafter as debris) are allowed to accumulate, the efficiency of the system may eventually be degraded. Further, such deposits (i.e., debris) may also cause the device to produce an audible oscillation.

There are various schemes for cleaning the emitter electrodes. In one embodiment, a sheet or strip of electrically insulating material extends from a base that is associated with the collector electrodes. When the collector electrodes are vertically removed from a top of the housing (and when also returned to the housing), the insulating material scrapes against the emitter electrodes, thereby frictionally cleaning the emitter electrodes. In another embodiment, beads or bead-like mechanisms can be used to clean the emitter electrodes. In particular, the beads have a channel through which the wire-like emitter electrodes extend. By rotating the housing upside down, gravity causes the beads to slide along the emitter electrodes to frictionally clean the emitter electrodes. Additional details are provided in the '417 patent and the '193 application, both of which are incorporated by reference.

FIG. 9 illustrates, schematically, an exemplary electro-kinetic conditioner system 100 in accordance with one embodiment of the present invention. The system includes a first set 110 of emitter electrodes 112 and a second set 120 of collector electrodes 122 located within a housing 102. While each set is shown as including multiple electrodes, a set alternatively includes as few as one electrode. In this embodiment, the emitter electrodes 112 are preferably connected to a positive terminal of a high voltage generator 140, and the collector electrodes 112 are preferably connected to a negative terminal of the high voltage generator 140. It is noted that embodiments of the present invention may also relate to electrode arrangements that include driver electrodes 132 which can also be removable from the housing 102. The exemplary housing 102 includes intake vents 104, outlet vents 106, and a base pedestal 108. Preferably, the housing 102 is free standing and/or upstandingly vertical and/or elongated. The vents 104 and 106 may be separate or combined into one unit. These vents 104, 106 ensure that adequate flow of ambient air is drawn into the housing 102 as well as made available to the electrodes, and that adequate flow of ionized cleaned air moves out from housing 102.

The present system 100 is preferably powered by an AC-DC power supply that is energizable or excitable using Switch, S1, along with the other user-operated switches such as a control dial 144, are preferably located on or near a top 103 of the housing 102. Additionally, a boost button 116, as well as one or more indicator lights 118, are alternatively located on the housing 102. The whole system is self-contained in that other than ambient air, nothing is required from beyond the housing 102, except perhaps an external operating voltage, for operation.

A user-liftable handle member 142 is shown affixed to the collector electrodes 122, which normally rest within the housing 102. The housing 102 also encloses the emitter electrodes 112 and, in one embodiment, the driver electrodes 132. In one embodiment, the collector electrodes 122 and/or the driver electrodes 132 are removable out of the housing 102 while the emitter electrodes 112 preferably remain within the housing 102. As is evident from FIG. 9, the collector electrodes 122 are able to be lifted vertically out from an aperture in the top 103 of the housing 102 along the longitudinal axis or direction of the elongated housing 102. This arrangement also allows for a user to return the collector electrodes 122, with the assistance of gravity, back to their resting position within the housing 102. It should be noted that the collector electrodes 122 are alternatively removable and insertable with respect to the housing in a horizontal instead of vertical direction.

During operation of the device 100, the high voltage generator 140 produces a high voltage potential difference between the emitter electrodes 112 and the collector electrodes 122. For example, the voltage to the emitter electrodes 112 is +6 KV, while the voltage to the collector electrodes 122 is −10 KV, thereby resulting in a 16 KV potential difference between the emitter electrodes 112 and collector electrodes 122. This potential difference produces a high intensity electric field that is highly concentrated around the emitter electrodes 112. Other voltage arrangements are also likely, as explained in the 10/717,420 application, which is incorporated by reference. More specifically, a corona discharge takes place from the emitter electrodes 112 to the collector electrodes 122 thereby producing charged ions. Particles (e.g., dust particles) in the vicinity of the emitter electrodes 112 are charged by the ions. The charged ions are repelled by the emitter electrodes 112 and are attracted to and collected by the collector electrodes 122.

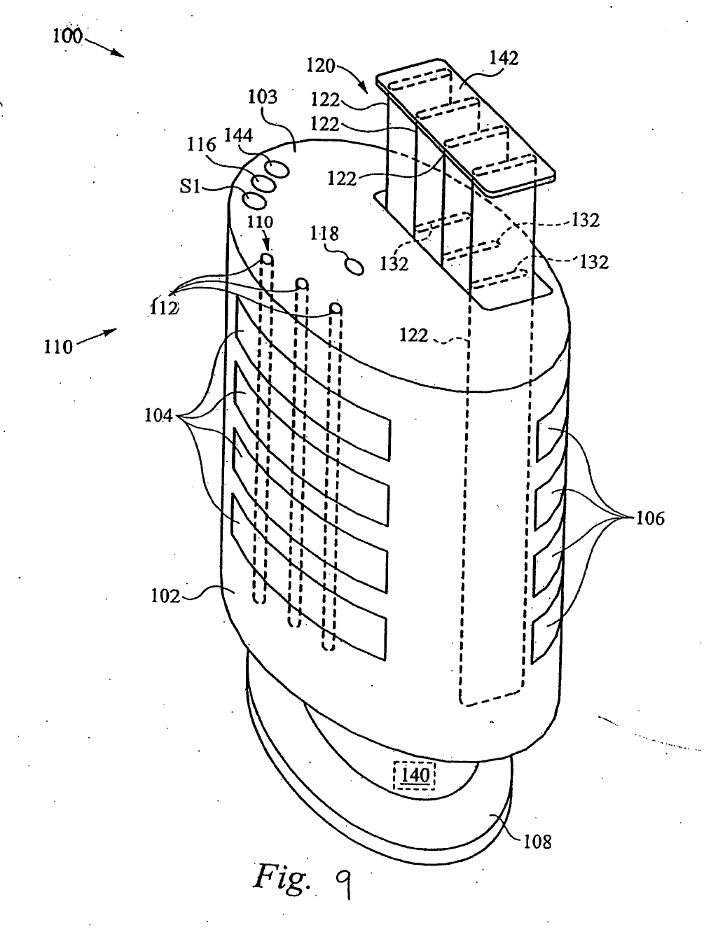

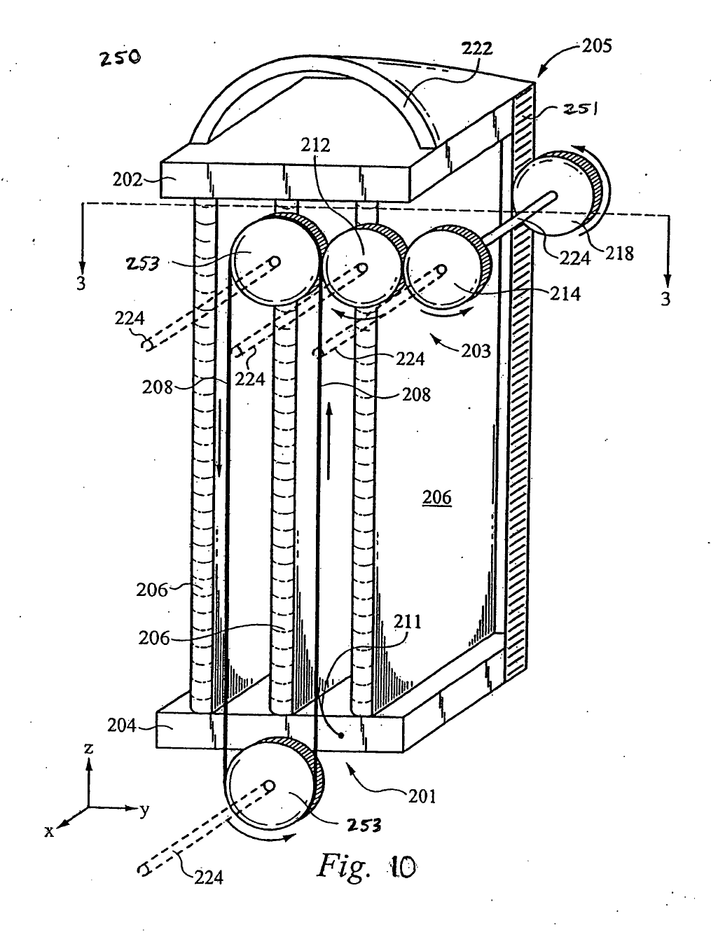

FIGS. 10 and 11 illustrate different views of one embodiment 250 of the present invention. As shown in FIG. 10, the emitter electrode is preferably a conductive emitter electrode wire 208 preferably disposed around at least two opposed rotatable wheels or pulleys 253 in a loop 201 along which the wire 208 is moved when the pulleys 253 are rotated. Although pulleys 253 are described herein, it is apparent to one skilled in the art that any other appropriate mechanism is alternatively used to instead of the pulleys to move the emitter electrode wires 208 about the loop 201. For brevity, the emitter electrode wire loop 201 is referred to hereinafter as the loop 201.

The loop 201 preferably forms two individual emitter wires 208 which are upstream of the leading edges of the collector electrodes 206. In another embodiment, the loop 201 is positioned such that the emitter wires 208 are located downstream of the leading edges of the collector electrodes 206. It should be noted that although only one loop 201 is shown in FIG. 2, any number of loops 201 are contemplated with the present invention. In one embodiment, the diameter of each pulley 253 is equal to the distance between two collector electrodes 206 although not necessarily. The loop 201 is preferably positioned such that the emitter wires 208 are upstream and between the adjacent collector electrodes 206. In another embodiment, the loop 201 is positioned such that the emitter wires 208 are directly upstream of the leading edges of the collector electrodes 206.

The emitter electrode wire 208 is preferably electrically connected to a positive terminal of the voltage source 140 (FIG. 17). In another embodiment, a conductive contact spring 211, as shown in FIG. 10, is connected to the voltage source 140, whereby the contact 211 touches the emitter electrode 208 to operate the electrode 208. Electrically, the voltage source 140 will impart a desired voltage potential to the emitter electrode wire 208, whereby each individual wire 208 simultaneously acts as an ion emitting surface when charged.

As shown in FIG. 10, the system 250 preferably includes a gear assembly 203 which includes the pulleys 253, an intermediate gear 212 and a set of gears 214, 218. The gears 214, 218 are preferably coupled to one another by a shaft 224 as shown in FIGS. 2 and 3. Although not shown, the shaft 224 or any other securing device secures the gears 214, 218 within the housing 102 such that the gears 214, 218 are held in place and are able to freely rotate. As shown in FIG. 10, the gear 214 meshes with the intermediate gear 212 and drives the intermediate gear 212 to rotate about the shaft 224, as shown by the arrows. The intermediate gear 212 is meshed with one or more pulleys 253, whereby rotation of the intermediate gear 212 causes the top pulley 253 to rotate about the shaft 224, as shown by the arrows. It should be noted that although the intermediate gear 212 is used in the embodiment, the intermediate gear 212 is alternatively not required. Although the intermediate gear 212 is shown coupled to the top pulley 253 in FIG. 10, it is contemplated that the intermediate gear 212 is alternatively, or additionally, coupled to the bottom pulley 253 or another pulley (not shown) positioned between the top and bottom pulleys 253. In one embodiment, all of the gears in the gear system 203 are of the same diameter and have the same gear dimensions. In another embodiment, at least one gear has a different diameter and/or gear dimension. Therefore, any number or variations of gear ratios are contemplated in the present emitter cleaning system.

As shown in FIG. 11, each of the pulleys 253 preferably has an inner peripheral surface 226 and an outer peripheral surface 255. In one embodiment, the emitter electrode wire 208 is disposed around the inner peripheral surface 226 of the pulleys. In the present invention, the outer peripheral surface 255 includes gear teeth 232 which are designed to mesh with another gear, preferably the intermediate gear 212, to rotate the pulleys 253.

As shown in FIG. 10, the system 250 includes a collector electrode assembly 205 which has a set of collector electrodes 206 attached between two opposing electrode mounting brackets 202, 204. The collector electrode assembly 205 preferably includes a handle 222 which is attached to the top mounting bracket 202. In the embodiment shown in FIG. 2, the collector electrode assembly 205 preferably includes a drive rack 251 between the top and bottom mounting brackets 202, 204 which interacts with the gear 218 of the gear assembly 203. Although the drive rack 251 is shown spanning the side of to assembly from the top to the bottom mounting bracket, the rack 251 is alternatively only disposed on the top and/or bottom mounting bracket 202, 204.

As previously discussed, the collector electrodes 206 are removable from the housing 102 (FIG. 9) by vertically pulling the handle 222 away from the top surface 103 of the housing 102 (FIG. 9). Further, the collector electrodes 206 are able to be vertically inserted into the device 100 by inserting the mounting brackets 202, 204 through the aperture in the top surface 103 of the device 100. The gear 218 of the gear assembly 203 is configured to mesh with the drive rack 251 of the collector electrode assembly 205. Generally, in one embodiment, removal and/or insertion of the collector electrodes 206, with respect to the housing, causes the drive rack 251 to rotate the gears 214 and 218 about the shaft 224. As the gear 218 rotates about the shaft 224, gear 214 causes the intermediate gear 212 to rotate the pulleys 253, and thereby move the emitter electrode wire 208 along the loop 201. The gear 218 can be a one-way pawl gear, whereby only removal or insertion of the collector electrode assembly 205 in the vertical direction will rotate the gear 218. It should be noted that the collector electrode assembly 205 is alternatively removable and insertable in a horizontal, instead of vertical, direction, whereby the lateral motion of the collector electrode assembly 205 causes the emitter electrode wire 208 to rotate.

The operation for cleaning the emitter electrode wire 208 will now be discussed. In one example, the user removes the collector electrode assembly 205 from the housing, whereby the vertical movement of the assembly 205 does not operate the gear assembly 203 due to the one-way pawl gear 218. In the example, as the collector electrode assembly 205 is inserted into the housing, the drive rack 251 catches and meshes with the gear 218. The downward movement of the collector assembly 205 and drive rack 251 in the vertical direction, as shown by the arrows, causes the meshed gear 218 as well as gear 214 to rotate about the shaft 224 in a counterclockwise direction. Since the gear 214 in the example is meshed with the intermediate gear 212, the counter-clockwise rotation of the gear 214 causes the intermediate gear 212 to rotate about its shaft 224 in the clockwise direction, as shown by the arrows. In addition, since the intermediate gear 212 is meshed with the top pulley 253 in the example, the clockwise rotation of the intermediate gear 212 causes the pulley 253 to rotate about its shaft 224 in the counter-clockwise direction, as shown by the arrows in FIG. 10. The rotation of the pulleys 253 thereby causes the emitter electrode wire 208 to move along the loop 201, as shown by the arrows in FIG. 10. The movement of the wire 208 along the loop 201 in effect cleans the emitter wire 208, as will discussed in more detail below. Of course, the system can be configured such that the emitter wire is moved along the loop 201 when the collector assembly 205 is alternatively or additionally lifted upward out of the housing 102.

FIG. 12 illustrates a schematic of another embodiment of the emitter electrode cleaning assembly 302 in accordance with the present invention. In the embodiment in FIG. 12, the collector electrode assembly 305 includes a drive rack 314 located on the bottom mounting bracket 304 which faces the emitter electrode loop 300. Alternatively, additionally, the drive rack 314 is located on the top mounting bracket of the collector electrode assembly 305.

In the embodiment shown in FIG. 12, the drive rack 314 is configured to mesh with a beveled intermediate gear 312 between the collector electrode assembly 305 and a set of pulleys 310 upon which the emitter electrode wire 308 is disposed. The beveled intermediate gear 312 is configured to rotate about the axis 98 and the beveled pulley 310 is configured to rotate about the axis 95, whereby the axes 95 and 98 are substantially perpendicular to one another. Alternatively, the axes 95 and 98 are positioned at any other angle with respect to one another. In operation, as the collector electrode assembly 305 is removed and/or inserted into the housing of the device, the vertical movement of the drive rack 314 will cause the intermediate gear 312 to rotate about axis 98. As the intermediate gear 312 rotates, it causes the pulleys 310 to rotate about axis 95, thereby causing the emitter electrode wire 308 to move around the loop 300. As discussed above, the system 302 is configured such that the gears move only when the collector electrode assembly 305 is moved in one vertical direction Alternatively, moving the collector electrode 205 in both vertical directions causes the electrode emitter wire 308 to move around the loop 300. It is also contemplated that the system can be configured to move the emitter wire 308 along the loop 301 when only the driver electrodes are removed from the housing.

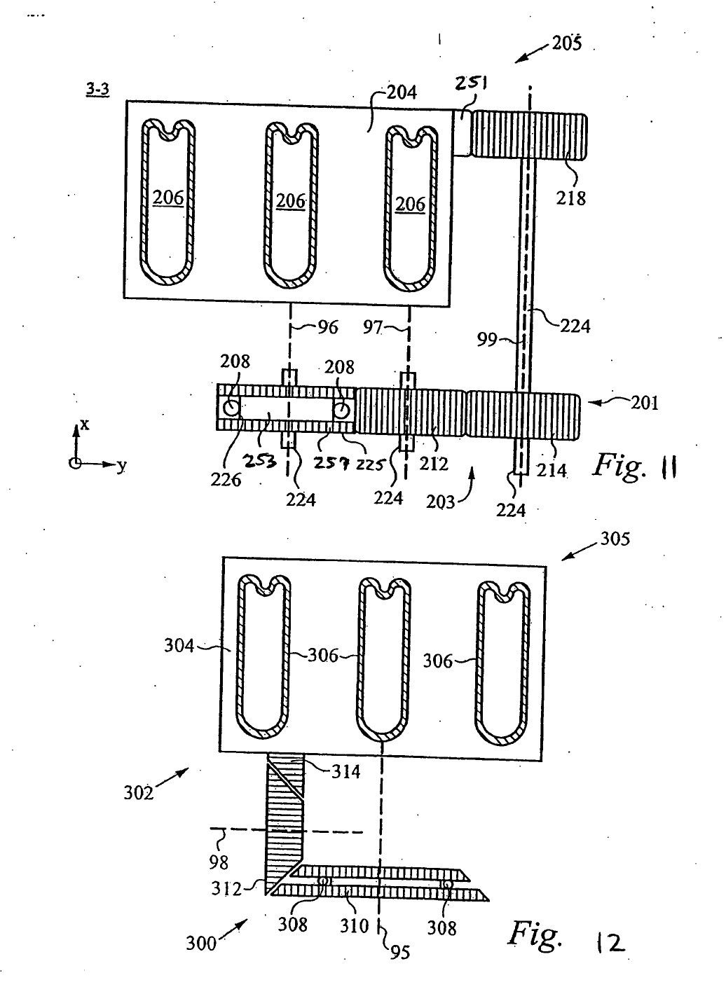

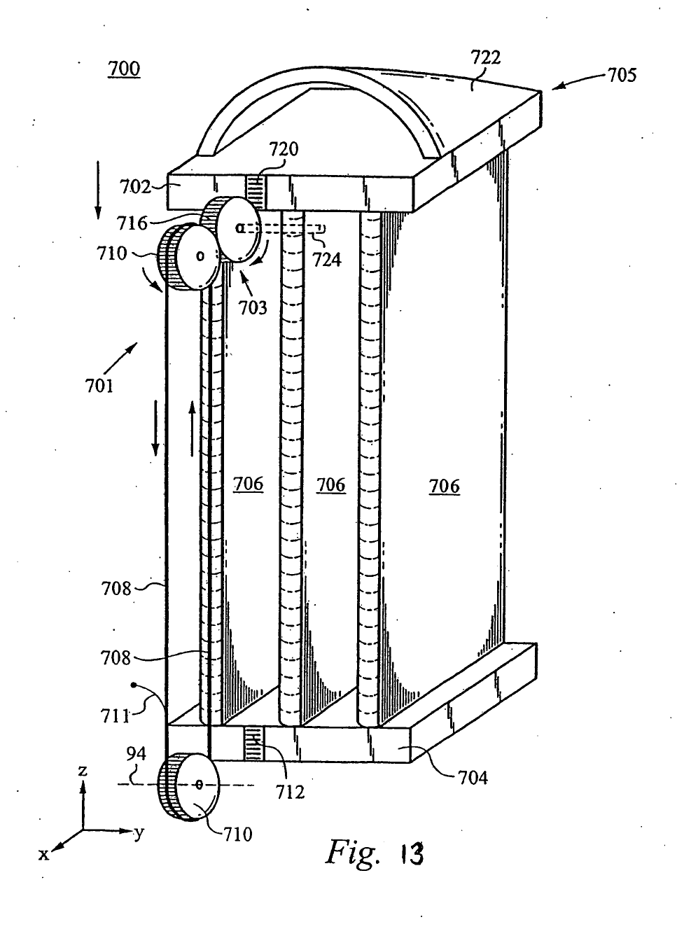

FIG. 13 illustrates a perspective view of the emitter electrode cleaning assembly 700 in accordance with one embodiment of the present invention. In the embodiment shown in FIG. 13, the assembly 700 includes the emitter electrode loop 701, an intermediate gear 716 which is configured to mesh with the top pulley 710 and one or both drive racks 712, 720 located on the top and bottom mounting brackets 702, 704 which mesh with the gear 716.

Unlike the emitter electrode wires in the embodiment shown in FIG. 10, the emitter electrode wires 708 in FIG. 13 are positioned such that one side of the wire loop 708 is downstream of the other side of the wire loop 701. The emitter electrode loop 701 shown in FIG. 13 is positioned such that the wires 708 are located upstream and between two adjacent collector electrodes 706. Alternatively, the emitter electrode loop 701 shown in FIG. 13 is positioned such that the wires 708 are upstream and directly in-line with the leading edge of a collector electrode 706. In another embodiment, one or both of the emitter electrodes 706 are positioned downstream of the leading edge of the collector electrodes. It should be noted that although only one emitter wire loop 701 is shown in FIG. 13, any number of emitter wire loops 701 are contemplated in the system 700.

As the collector electrode assembly 705 is moved vertically downward, the drive rack 712 first meshes with the intermediate gear 716, whereby the downward movement of the drive rack 712 causes the intermediate gear 716 to rotate clockwise about its shaft 724. The clockwise rotation of the intermediate gear 716 causes the meshed pulley 710 to rotate counter-clockwise about its center, thereby causing the emitter electrode wire 708 to move along the loop 701, as shown by the arrows in FIG. 13. As the collector electrode assembly 705 is moved downward, the bottom drive rack 712 moves past and out of contact with the intermediate gear 716. Accordingly, the intermediate gear 716 and the emitter wire loop 708 will not rotate when the intermediate gear 716 is not in appropriate contact with the drive rack 712. As the collector electrode assembly 705 moves further down into the housing, the top drive rack then meshes with and turns the intermediate gear 716, thereby effectively further rotating the pulleys 710 and moving the wire 708 along the loop 701.

In one embodiment, the upward vertical movement of the collector electrode assembly 705 (i.e. removal of the assembly 705 from the housing) also actuates the intermediate gear 716 and thus rotates the pulleys 710 to move the wire 708 along the loop 701. In another embodiment, the intermediate gear is a one-way gear which is actuated only when the collector electrode assembly 705 moves in one direction. In one embodiment, the collector electrode assembly 705 includes a drive gear on either the top or bottom mounting bracket. In another embodiment, the gears can be configured to rotate the pulleys 710 in the same direction when the collector electrode assembly 705 is inserted and removed from the housing 102. In another embodiment, the collector electrode assembly 705 is removable and insertable in a horizontal, instead of vertical, direction, whereby the lateral motion of the collector electrode assembly 705 causes the gear assembly to actuate to cause emitter electrode wire 708 to move along the loop 701. It is also contemplated that the system can be configured to move the emitter wire 708 along the loop 701 when only the driver electrodes are removed from the housing.

FIGS. 14-16 illustrate various mechanisms for removing debris from the wire loop emitter electrodes in accordance with embodiments of the present invention. Referring to FIG. 14, a pair of pulleys 410 and a single wire emitter electrode 408 in a looped configuration are shown. Also shown is a scraper contact 404 which is used to frictionally clean the emitter electrode wire 408 as the emitter electrode wire 408 is moved along the loop. In one embodiment, the scraper contact 404 is electrically connected to the voltage source 140 (FIG. 17), whereby the scraper contact 404 also energizes the emitter electrode 408.

In accordance with one embodiment of the present invention, the scraper contact 404 is made from a sheet or strip of flexible insulating material, such as those marketed under the trademarks MYLAR and KAPTON. Alternatively, the scraper is made of a non-flexible material. The scraper 404 is preferably made of an insulating material includes a first end 402 preferably attached to the housing 102 (FIG. 9) and a free end 406 that scrapes against the emitter electrode wire 408 as the wire 408 is rotated. The scraper contact 404 faces the emitter electrode wire 408 and is preferably in a plane perpendicular to the length of the wire 408, although not necessarily. The material of the scraper contact 404 preferably has high voltage breakdown as well as a high dielectric constant, which allows the scraper to withstand high temperature. Alternatively, the scraper contact 404 is conductive and is electrically connected to the voltage source 140. Although not required, a slit 407 is located (e.g. cut) in the free end 406 of the contact 404 such that wire 408 fits into the slit 407 and/or is substantially surrounded by the slit 407. Whenever the pulleys 410 are rotated to move the wire 408, the wire 408 frictionally scrapes against the free end 406 of the scraper contact 404 (or the slit 407 cut therein), causing debris to be removed from the wire 408 and thereby cleaning the wire 408. In embodiments including more than one wire loop emitter electrode 408, a separate scraper contact 404 for each wire electrode 408 is utilized. Alternatively, a single scraper contact 404 is utilized and is wide enough to clean more than one, and possibly all, of the emitter wires 408.

Referring to FIG. 15, in accordance with another embodiment of the present invention, an additional rotatable pulley or cleaning wheel 502 is contact with a portion of the emitter wire 508 to clean the wire 508 as the wire 508 moves along the loop. In one embodiment, the cleaning wheel 502 is located adjacent to one or more of the pulleys 551 upon which the emitter wire 508 is disposed. Alternatively, or additionally, the cleaning wheel 506 (shown in phantom in FIG. 15) is placed at any other locations adjacent the wire loop emitter electrode 508.

The outer surface 504 of the cleaning wheel 502 is preferably rough or bristled in one embodiment, so that the cleaning wheel 502 able to clean debris from the electrode 508 as the electrode 508 moves in relation to the wheel 502. Friction between the surfaces of the emitter wire 508 and the cleaning wheel 502 can cause the cleaning wheel 502 to rotate when the emitter wire 508 moves along the loop. Accordingly, there is no need for a separate motor or other mechanism for rotating the cleaning wheel 502, although one can be included. It is also possible that the rotation of the cleaning wheel 502 could be used to cause one of the pulleys 551 to rotate, thereby causing the emitter wire 508 to move along the loop. It should be noted that the cleaning mechanism discussed above are in no way limiting and other mechanisms and devices are contemplated which clean the emitter wire. One possible cleaning mechanism is one or more beads or bead-like mechanisms having a channel which the emitter wire passes through, whereby the emitter wire is cleaned by scraping against the inside walls of the channel when the bead and wire are moved in relation to one another. More details of the bead are discussed above and in the '417 patent referenced above.

Referring now to FIG. 16, in accordance with another embodiment of the present invention, a brush 602 is located adjacent to and in contact with the emitter wire 608. The brush 602 cleans debris from the emitter electrode 608 as the electrode 608 moves past the brush 602 along the loop 612. The brush 602 includes bristles 604 which extend at least as far as, and possibly past, the electrode 608. The bristles 604 preferably have a high voltage breakdown, have a high dielectric constant, and can withstand high temperature. The brush 602 is preferably attached within the housing 102 so that the bristles 604 extend toward the emitter electrode 608. In FIG. 16, the brush 602 is shown as being located between the upper and lower pulleys 610. It is also possible that the brush 602 is in contact with one or both of the pulleys 610. In another embodiment, the brush 602 is positioned between the emitter electrode wires 608, such that the bristles 604 simultaneously clean the wires 608 on both sides of the loop. Alternatively, a single brush 602 can be made wide enough to clean more than one, and possibly all, of the wire loop electrodes 608 if more than one set of electrode assemblies are present in the housing.

In another embodiment, the pulleys themselves include a frictional surface in contact with the emitter wire such that the frictional surface cleans debris from the emitter wire as the wire is along the loop. For example, one or more of the pulleys include a felt or other soft material along the interior radial surface which cleans the wire when the wire comes into contact with the interior radial surface.

FIG. 17 illustrates schematically, an exemplary electro-kinetic conditioner system 100. The system includes a first array 110 (i.e., emitter array) of emitter electrodes 112, a second array 120 (i.e., collector array) of collector electrodes 122 and a third array 130 of driver electrodes 130. While each array is shown as including multiple electrodes, an array can include as few as one electrode. In this embodiment, the emitter array 110 is shown as being connected to a positive terminal of a high voltage generator 140, and the collector array 120 is shown as being connected to a negative terminal of the high voltage generator 140. The third array 130 of driver electrodes 132 is shown as being grounded. Each driver electrode can be insulated, as disclosed in U.S. patent application Ser. No., 10/717,420, filed Nov. 19, 2003, which is incorporated herein by reference. Further, it is noted that embodiments of the present invention also relate to electrode arrangements that do not include driver electrodes 132.

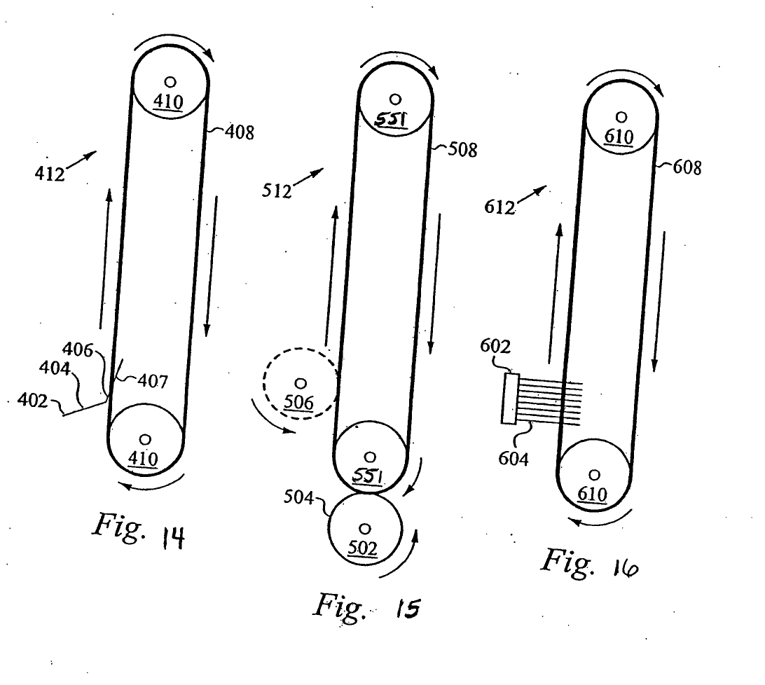

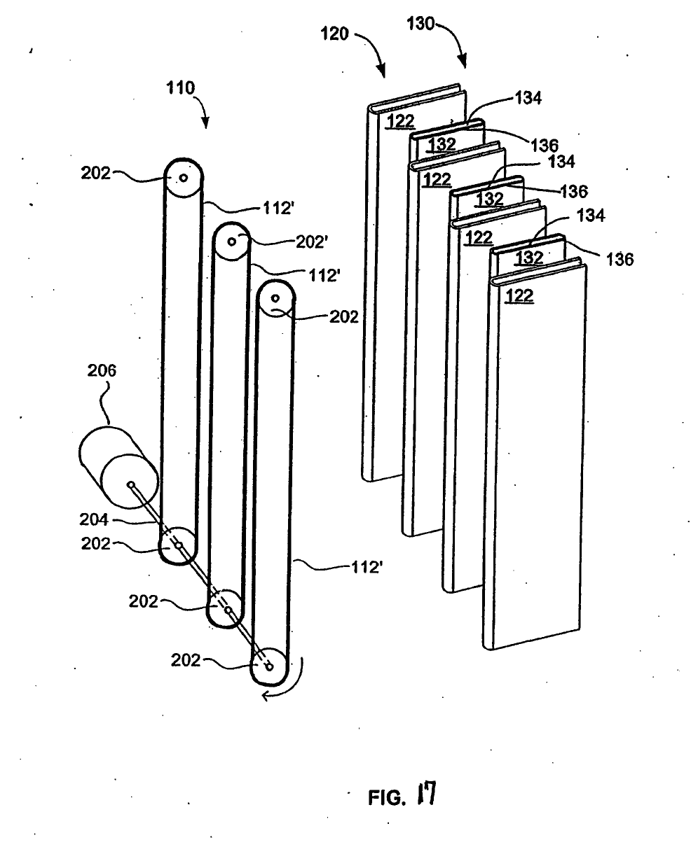

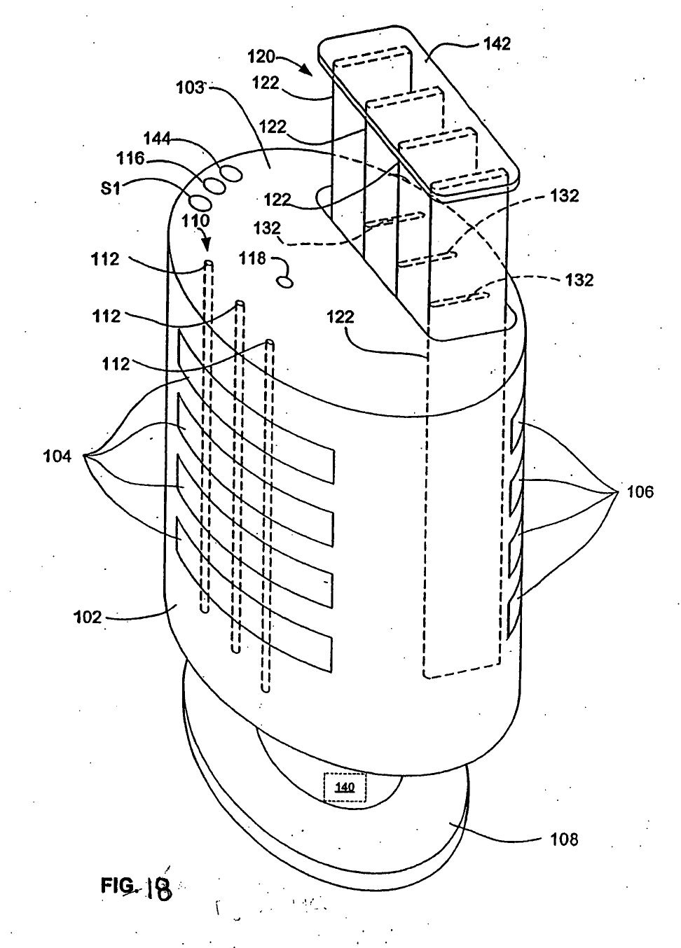

As shown in FIG. 18, the above described electrodes are likely within a housing 102. The exemplary housing 102 includes intake vents 104, outlet vents 106, and a base pedestal 108. Preferably, the housing 102 is free standing and/or upstandingly vertical and/or elongated. The base 108, which may be pivotally mounted to the remainder of the housing, allows the housing 102 to remain in a vertical position.

The electro-kinetic transporter and conditioner system is likely powered by an AC-DC power supply that is energizable or excitable using switch S1. Switch S1, along with the other user operated switches such as a control dial 144, are preferably located on or near a top 103 of the housing 102. Additional, a boost button 116, as well as one or more indicator lights 118, can be located on the housing 102. The whole system is self-contained in that other than ambient air, nothing is required from beyond the housing 102, except perhaps an external operating voltage, for operation.

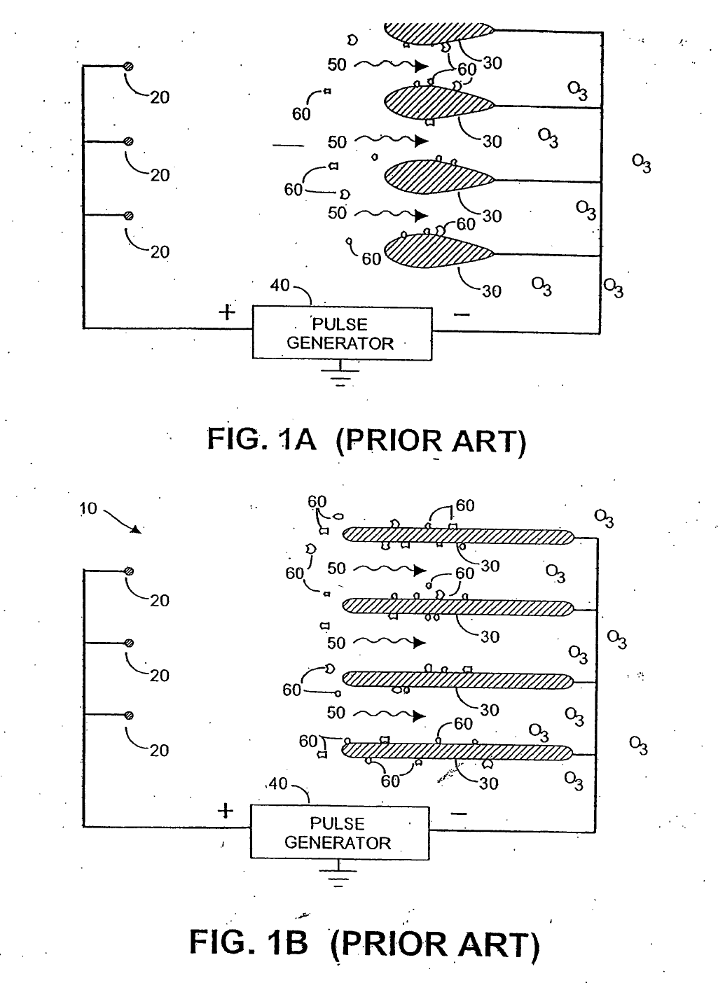

A user-liftable handle member 142 is shown as being affixed the collector array 120 of collector electrodes 122, which normally rests within the housing 102. The housing 102 also encloses the array 110 of emitter electrodes 112 and the array 130 of driver electrodes 132. In the embodiment shown, the handle member 142 can be used to lift the collector array 110 upward causing the collector electrodes 122 to telescope out of the top of the housing 102 and, if desired, out of the housing 102 for cleaning, while the emitter electrode array 110 and the driver electrodes array 130 remain within the housing 102. As is evident from FIG. 1B, the collector array 110 can be lifted vertically out from the top 103 of the housing along the longitudinal axis or direction of the elongated housing 102. This arrangement with the collector electrodes 122 removable through a top portion of the housing 102, makes it easy for a user to pull the collector electrodes 122 out for cleaning, and to return the collector electrodes 122, with the assistance of gravity, back to their resting position within the housing 102. If desired, the driver array 130 may be made similarly removable.

There need be no real distinction between vents 104 and 106, except their locations relative to the electrodes. These vents serve to ensure that an adequate flow of ambient air can be drawn into the housing 102 and made available to the electrodes, and that an adequate flow of ionized cleaned air moves out from housing 102.

During operation of system 100, the high voltage generator 140 produces a high voltage potential difference between the emitter electrodes 112 (of the emitter array 110) and the collector electrodes 122 (of the second array 120). For example, the voltage on the emitter electrodes 112 can be +6 KV, while the voltage on the collector electrodes 122 can be −10 KV, resulting in a 16 KV potential difference between the emitter electrodes 112 and collector electrodes 122. This potential difference will produces a high intensity electric field that is highly concentrated around the emitter electrodes 112. More specifically, a corona discharge takes place from the emitter electrodes 112 to the collector electrodes 122, producing charged ions Particles (e.g., dust particles) in the vicinity of the emitter electrodes 112 are charged by the ions. The charged ions are repelled by the emitter electrodes 112, and are attracted to and deposited on the collector electrodes 122.

In embodiments that include driver electrodes 132 (which are preferably, but not necessarily insulated), further electric fields are produced between the driver electrodes 132 and the collector electrodes 122, which further push the particles toward the collector electrodes 122. Generally, the greater this electric field between the driver electrodes 132 and collector electrodes 122, the greater the particle collection efficiency.

The freestanding housing 102 can be placed in a room (e.g., near a corner of a room) to thereby clean the air in the room, circulate the air in the room, and increase the concentration of negative ions in the room. The number of electrodes shown in FIG. 1 is merely exemplary, and is not meant to be limiting. As mentioned above, a system 100 can include as few as one emitter electrode 112 and one collector electrode 122.

Other voltage arrangements are also likely, as explained in the '420 application, which was incorporated by reference above. For example, the emitter electrodes 112 can be grounded (rather than being connected to the positive output terminal of the high voltage generator 140), while the collector electrodes 122 are still negatively charged, and the driver electrodes 132 are still grounded. Alternatively, the driver electrodes 132 can be connected to the positive output terminal of the high voltage generator 140 (rather than being grounded), the collector electrodes 122 are negatively charged, and the emitter electrodes 112 are still grounded. In another arrangement, the emitter electrodes 112 and driver electrodes 132 can be grounded, while the collector electrodes 122 have a high negative voltage potential or a high positive voltage potential. It is also possible that the instead of grounding certain portions of the electrode arrangement, the entire arrangement can float (e.g., the driver electrodes 132 and the emitter electrodes 112 can be at a floating voltage potential, with the collector electrodes 122 offset from the floating voltage potential). Other voltage variations are also possible while still being within the spirit as scope of the present invention.

The emitter electrodes 112 are likely wire-shaped, and are likely manufactured from a wire or, if thicker than a typical wire, still has the general appearance of a wire or rod. While the collector electrodes are typically in need of cleaning more often then the emitter electrodes, the emitter electrodes can eventually accumulate a deposited layer or coating of fine ash-like material. Additionally, dendrites may grow on the emitter electrodes. If such deposits are allowed to accumulate, the collecting efficiency of the system will eventually be degraded. Further, such deposits may produce an audible oscillation that can be annoying to persons near the system. Embodiments of the present invention relate to new systems and methods for cleaning emitter electrodes

FIG. 19 illustrates emitter electrodes 112′ according to embodiments of the present invention. In these embodiments, each emitter electrode 112′ is made from a loop of wire that is strung around a pair of rotatable wheels or pulleys 221. In the arrangement shown, the plane of the each wire loop is generally parallel with the flat downstream walls of the collector electrodes 122. With this arrangement, half of each wire loop 112′ will be closer to the collector electrodes 122 than the other half of that loop.

In another embodiment (not shown), each wire loop 112′ is in a common plane, which is generally perpendicular to the downstream flat walls of the collector electrodes 122. In such an embodiment, both halves of each wire loop 112′ will be equally distant from the collector electrodes 122, allowing each half of the wire loop 112′ to simultaneously act as an ion emitting surface. By making the diameter of each pulley equal to a desired distance between adjacent emitter electrodes, the two halves of each wire loop 112′ will be the desired distance apart. It is also within the scope of the present invention that the wire loop emitter electrodes 112′ are not parallel with the collector electrodes 122.

For each pair of pulleys 221, at least a portion of one of the pulleys 221 can be electrically connected to the positive or negative terminal of the voltage source 140 (or to ground), to thereby impart a desired voltage potential to the wire loop emitter electrode 112′ strung around the pulleys 221

Each wire loop emitter electrode 112′ can be rotated by rotating one of the pair of pulleys 221 around which the wire 112′ is strung. For example, rotation of the lower pulleys 221 (and/or upper pulleys 221) will cause the wire loop emitter electrodes 112′ to rotate, allowing for frictional cleaning of the wire emitter electrodes 112′, as will be described with reference to FIGS. 20-22. A common shaft 223 can connect all of the lower pulleys 221 (or upper pulleys), thereby allowing a single motor 227 or manual mechanism to rotate all of the wire loop emitter electrodes 112′. Alternatively, the pulleys can be connected through a gear system, or the like. Where a motor is used to rotate the pulleys, a button to activate the motor can be placed on the system housing 102. In other embodiments, the motor can be periodically activated, or activated in response to some event, such as detection of arcing, or detection of the system being turned on, etc. Alternatively, a crank, thumbwheel, or other manual mechanism can be placed on (or be accessible from) the system housing 102 and used to allow for manual rotation of the pulleys 221. In accordance with an embodiment of the present invention, an indicator (e.g., a light) can tell a user when they should use a manual mechanism to rotate, and thus clean, the wire emitter electrodes 112′.

Referring now to FIG. 20, a pair of pulleys 221 and a single wire loop emitter electrode 112′ are shown. Also shown is a scraper 231, which is used to frictionally clean the emitter electrode 112′ as it is rotated. In accordance with an embodiment of the present invention, the scraper 231 is made from a sheet or strip of flexible insulating material, such as those marketed under the trademarks MYLAR and KAPTON. The sheet of insulating material includes a first end 235 attached within the housing 102 and a free end 237 that scrapes against the emitter electrode 112′ as it is rotated. This sheet 231 can be attached within the housing so that the sheet faces the emitter electrodes 112′ and is nominally in a plane perpendicular the emitter electrode 112′. Such sheet material preferably has high voltage breakdown, high dielectric constant, can withstand high temperature, and is flexible. Although not required, a slit can be located (e.g., cut) in the free end 237 of the sheet such that wire electrode fits 112′ into the slit.

Whenever one of the pulleys 221 is rotated, the wire loop emitter electrode 112′ rotates and frictionally scrapes against the free end 237 of the scraper 231 (or the slit cut therein), causing debris to be frictionally removed from the wire loop emitter electrode 112′, thereby cleaning the electrode 112′.

In accordance with another embodiment of the present invention, the scraper 231 is inflexible, and has a free end biased against the wire electrode 112′, so that it scrapes against the wire electrode 112′ as the wire electrode 112′ rotates. As with the flexible embodiment, the inflexible scraper 231 may or may not include a slit within which with wire electrode fits 112′.

In embodiments including more than one wire loop emitter electrode 112′, there can be a separate scraper 231 for each wire loop electrode 112′. Alternatively, a single scraper 231 can be made wide enough to clean more than one, and possible all, of the wire loop electrodes 112′. Such a scraper 231 may or may not include a slit that corresponds to each electrode 112′ that it cleans.

Referring now to FIG. 21, in accordance with another embodiment of the present invention, an additional rotatable pulley or wheel 239 is located adjacent one of the pulleys 221 about which the wire loop emitter electrode 112′ rotates. An outer surface 257 of the wheel 239, referred to hereafter as a cleaning wheel, contacts a portion of the emitter electrode 112′ as the electrode 112′ is rotated about the pulleys 221. The outer surface 257 is preferably rough or bristled, so that the cleaning wheel 239 cleans debris from the electrode 112′ as it comes in contact with the electrode 112′. Friction between the wire loop emitter electrode 112′ and the outer surface 257 of the cleaning wheel 239 will cause the cleaning wheel 239 to rotate, when the wire loop emitter electrode 112′ rotates. Accordingly, there is no need for a separate motor or other mechanism for rotating the cleaning wheel 239, although one can be included. It is also possible that the rotation of the cleaning wheel 239 could be used to cause one of the pulleys 221 to rotate, thereby causing the rotation of the wire loop emitter electrode 112′. It is also possible that gears, or the like, connect a pulley 221 and the cleaning wheel 239, so that they both are rotated by a common motor or manual mechanism. Preferably, the cleaning wheel 239 and adjacent pulley 221 rotate in opposite directions, as shown in FIG. 21.

Alternatively, or additionally, a cleaning wheel 239′ be placed at other locations adjacent the wire loop emitter electrode 112′, as shown in phantom.

Referring now to FIG. 22, in accordance with another embodiment of the present invention, a brush 245 is located adjacent to and in contact with the wire loop emitter electrode 112′. The brush 245 cleans debris from the emitter electrode 112′ as it rotates past the brush 245. The brush 245 includes bristles 247 which extend at least as far as, and possibly past, an adjacent portion of the electrode 112′. The bristles 247 preferably have a high voltage breakdown, have a high dielectric constant, and can withstand high temperature. The brush 245 can be attached within the housing 102 so that the bristles 247 extend toward the emitter electrode 112′. In FIG. 22, the brush 245 is shown as being located between the two pulleys 230. It is also possible that the brush 245 can be located adjacent one of the pulleys 221.

In embodiments including more than one wire loop emitter electrode 112′, there can be a separate brush 245 for each wire loop electrode 112′. Alternatively, a single brush 245 can be made wide enough to clean more than one, and possible all, of the wire loop electrodes 112′.

It is to be understood that in the embodiments of FIGS. 19, 20, 21 and 22, if desired, the portion of each wire loop 112′ that is further from the collector electrodes 122 can be shielded from the portion of each wire loop 112′ that is closest to the collector electrodes 122, so that the further portion of the wire loop 112′ does not interfere with the portion of the wire loop 112′ that is closest to the collector electrode 122 This can be accomplished, for example by including an insulating shield or wall between each pair of pulleys 221.

Referring now to FIG. 23, in another embodiment of the present invention, a wire emitter electrode 112″ is unwound from one pulley or spool 221 (e.g., the lower spool) and wound onto a second pulley or spool 221 (e.g., the upper spool). As with the above described embodiments, a motor, hand crank, thumb wheel, or any other mechanism for rotating the windup pulley 221 (e.g., the lower wheel) can be used. If a motor is used, the motor can be periodically activated, or activated in response to some event, such as detection of arcing, or detection of the system being turned on, detection of a button being pressed, etc. In this embodiment, rather than cleaning the wire emitter electrode 112″, a debris covered portion of the wire 112″ gets wound up, and an unused clean portion of the wire 112″ gets unwound and exposed, to act as the emitter. Eventually, when the wire 112″ is used up, a new spool or wheel 221 of wire 112″ can be installed. This embodiment is somewhat analogous to a rotating cloth towel machine, which is commonly used in commercial restrooms.

In embodiments including more than one emitter electrode, there can be a separate spool 221 for each emitter electrode 112″. Alternatively, a single spool can be made wide enough to contain multiple wound emitter electrodes 112″, which are spread apart from one another along the wide spool.

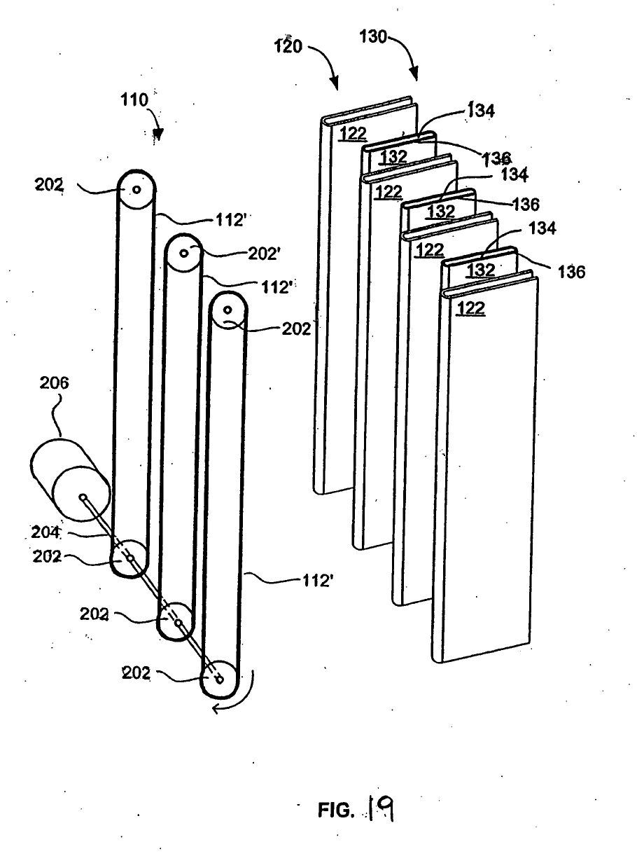

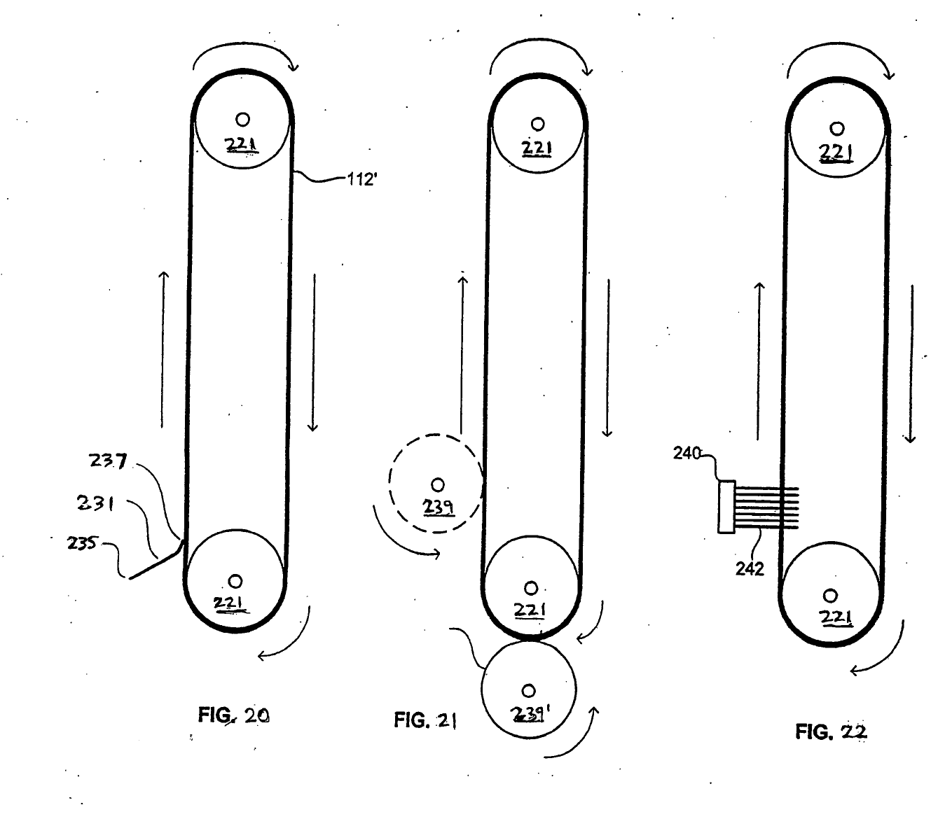

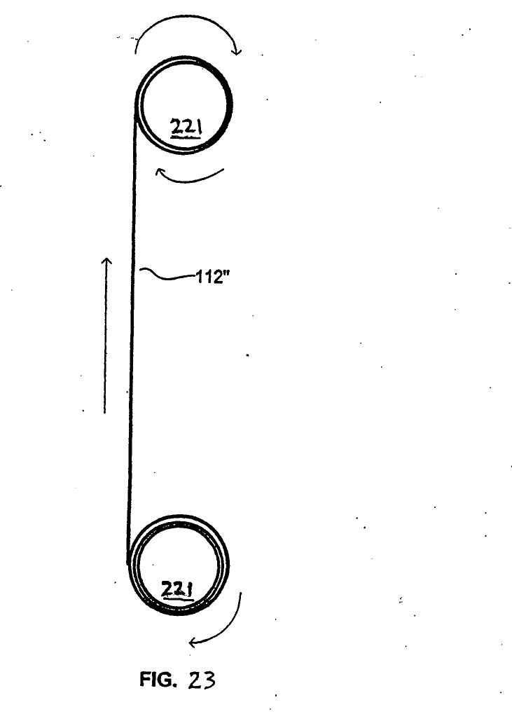

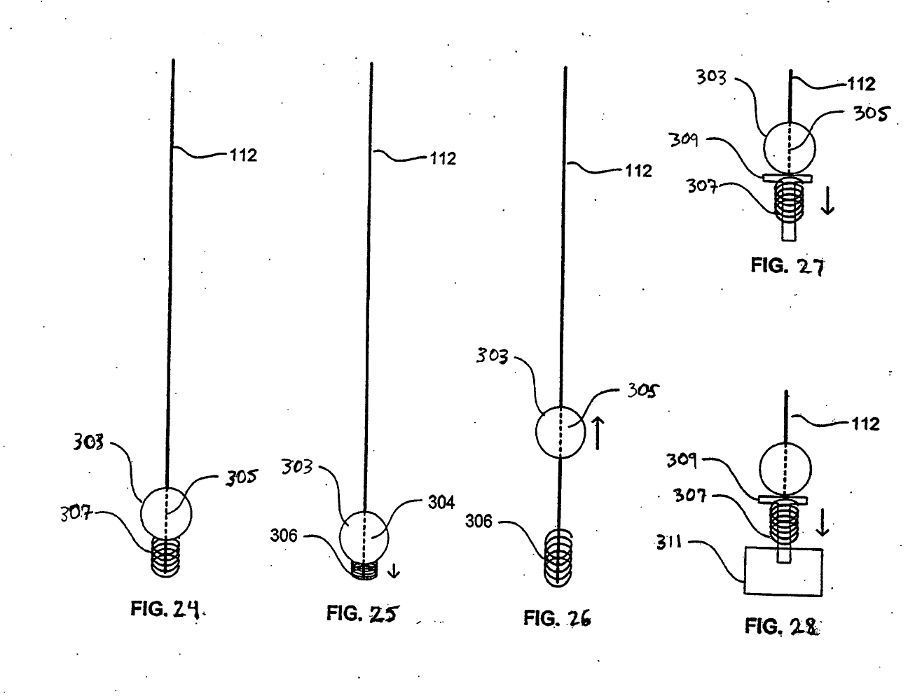

FIGS. 24-28 will now be used to describe how a spring loaded cleaning member 302, can be used to clean an emitter electrode 112. As shown in FIG. 24, the member 303 will normally rest near the bottom of the emitter electrode 112, above a spring 307 (but not necessarily in direct contact with the spring 307, as can be appreciated from FIGS. 27 and 28). The emitter electrode 112 passes through a channel 305 through the member 303. The member 303 is preferably fabricated from a material that can withstand high temperature and high voltage, and is not likely to char, e.g., ceramic, glass, or an appropriate plastic.

In response to the spring 307 being compacted or downwardly biased, as shown in FIG. 25, the spring (when released) will cause the member 303 to move upward, and more specifically project upward, along the emitter electrode 112, as shown in FIG. 26. Preferably, the force produced by the spring 307 is sufficient to cause the member 303 to project upward the entire length of the emitter electrode 112. Eventually, gravity will cause the member 303 to travel downward along the emitter electrode 112, where it will eventually come to rest near the bottom of the emitter electrode 112, where it started. The member 303 will frictionally remove debris from the emitter electrode 112 is it moves upward, and as it moves downward.

The member 303 need not be circular, and may instead have any other shape, such as cylindrical, bell shaped, square, oval, etc. While it may be easiest to form the channel 305 with a circular cross-section, the cross-section could in fact be non-circular, e.g., triangular, square, irregular shaped, etc. The channel 305 maybe formed through the center of the member 303, or may be formed off-center to give asymmetry to the member 303. An off-centered member will have a mechanical moment and will tend to slightly tension the emitter electrode 112 as the member slides up and down, and can improve cleaning characteristics. It is also possible that the channel be slightly inclined, to impart a different frictional cleaning action.

The spring 307 can be compressed (i.e., loaded) in various manners. In accordance with an embodiment of the present invention, a plunger-like mechanism 309 is used to compress the spring 307, similar to how a plunger compresses a spring in a pin-ball machine. The plunger-like mechanism 309 can be manually pulled downward. As shown in FIG. 28, in other embodiments, the plunger 309 can be part of, or controlled by, an electromagnetic solenoid or a piezoelectric actuator mechanism 311, which can be used to pull the plunger-like mechanism 309 downward. When the plunger 309 is released, manually, or electrically, the spring 307 will cause the member 303 to project upward along the emitter electrode 112, as explained above. Other ways of controlling the plunger 309 are also within the spirit and scope of the present invention.

Where a solenoid or actuator mechanism 311 is used, a button to activate the mechanism can be placed on the system housing (e.g., 102). In another embodiment, the solenoid or actuator 311 can be activated periodically, or activated in response to some event, such as detection of arcing, or detection of the system being turned on, etc. In accordance with an embodiment of the present invention, an indicator (e.g., a light) can tell a user when they should manually pull the plunger 309, which can be arranged in such a manner that it is accessible from outside the housing 102.

In embodiments including more than one emitter electrode 112, there can be a separate cleaning member 303 and spring 307 for each emitter electrode 112. There can also be a separate plunger 309, and even a separate electromagnetic solenoid or piezoelectric actuator mechanism 311, for each cleaning member 305. Alternatively, a plurality of plungers 309 can be linked together and controlled by a single electromagnetic solenoid or piezoelectric actuator mechanism 311. It is even possible that a wide cleaning member 303 can include multiple channels 305, and thus be used to clean more than one, and possible all, of the emitter electrodes 112.

In another embodiment, described with reference to FIGS. 29 and 30, a lever 401 pivots about a fulcrum 403. A first end 405 of the lever 401 can extend outside the housing 102 (e.g., through an opening in the housing 102) so that it is accessible to a user. A second end 409 of the lever 401 rests under the cleaning member 303. As shown in FIG. 30, when a downward force is applied to the first end 405 of the lever 401 (e.g., due to a user pushing down with their finger), the second end 409 pivots upward, causing the member 303 to project upward (and eventually fall downward), thereby frictionally cleaning debris from the emitter electrode 112.

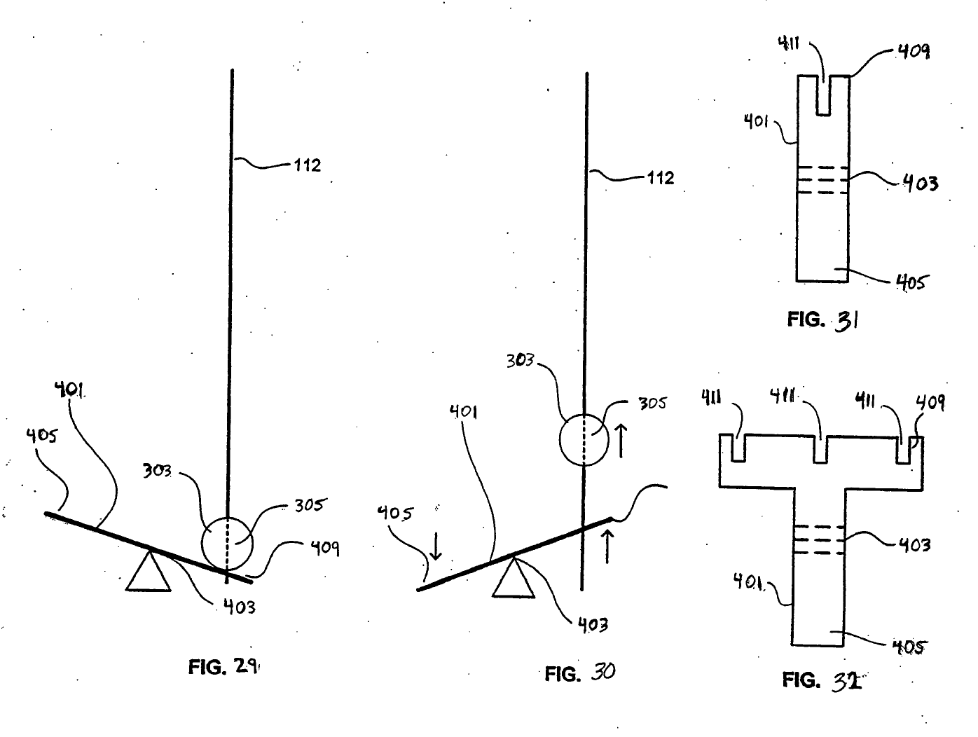

Referring to FIG. 31, which is a top view of an exemplary lever 401, the second end 409 likely includes a slit 410, so that the second end 409 can straddle the emitter electrode 112 and be under the member 303 when it is at rest. The lever 401 and fulcrum 403 can be arranged and/or weighted such that the second end 409 falls downward when the user stops pushing down on the first end 405. Alternatively, or additionally, the member 303 will cause the second end 409 to move downward when the member 303 travels back down the emitter electrode 112 due to gravity.

In embodiments including more than one emitter electrode 112, there can be a separate lever 401 for each electrode 112. The first ends 405 of the multiple levers 401 can be connected together so that a user need only push down one lever to clean multiple emitter electrodes 112. Alternatively, the second end 409 of a single lever 401 can be made wide enough such that when it pivots upward, it forces multiple cleaning members 303 upward, and thus, a single lever 401 can be used to clean multiple emitter electrodes 112. In such an embodiment, the second end 409 likely includes a slit 411 for each emitter electrode 112 that it is used to clean, as shown in FIG. 32, which is the top view of a lever 401 according to an alternative embodiment of the present invention. This enables the second end 409 to straddle multiple emitter electrodes 112 and be under multiple cleaning members 303 when they are at rest. It is also possible that a single lever 401 can be used to force a single cleaning member 303 upward, where the single member 303 is a wide cleaning member that includes multiple channels 305, to thereby clean multiple, and possible all, of the emitter electrodes 112.

The lever 401 can be controlled by an electromagnetic solenoid or a piezoelectric actuator mechanism, similar to the mechanism 311 discussed above with reference to FIG. 28. Other ways of, and mechanisms for, controlling the lever 401 are also within the spirit and scope of the present invention.

Where a solenoid or actuator mechanism is used, a button to activate the mechanism can be placed on the system housing (e.g., 102). In another embodiment, the solenoid or actuator can be activated periodically, or activated in response to some event, such as detection of arcing, or detection of the system being turned on, etc. In accordance with an embodiment of the present invention, an indicator (e.g., a light) can tell a user when they should manually use the lever 401 to clean the emitter electrode(s) 112.

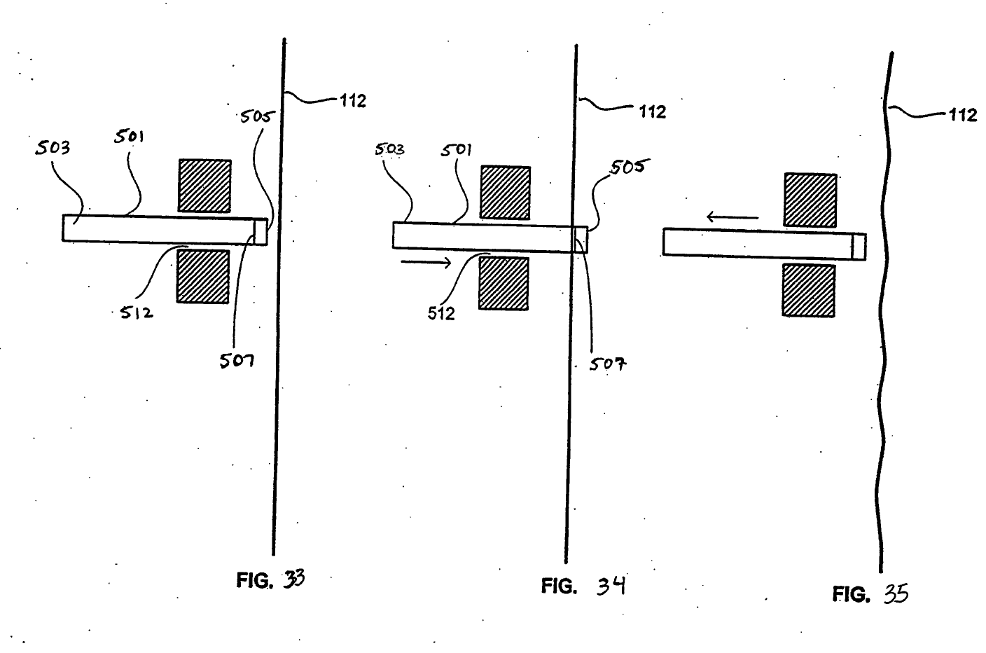

In another embodiment, described with reference to FIGS. 33-35, a plucker 501 is used to pluck an emitter electrode 112, to thereby vibrate the emitter electrode 112, causing debris to fall off the emitter electrode. The plucker 501 includes a first end 503, which can extend outside the housing 102 (e.g., through an opening in the housing 102) so that it is accessible to a user. A second end 505 of the plucker 501 includes a lip 507 or similar structure that can be used to engage the emitter electrode 112. The plucker 501 can rest in a channel 512 or be supported by another structure. As shown in FIG. 34, the plucker 501 can be moved toward the emitter electrode 112, such that the lip 507 engages the emitter electrode 112. When the plucker 501 is then pulled away from the emitter electrode 112, the emitter electrode 112 will vibrate, as exaggeratedly shown in FIG. 35. Such vibration will cause at least a portion of the debris that accumulates on the emitter electrode 112 to shake free.

In an alternative embodiment, rather than having a plucker 501 that moves toward and away from the emitter electrode 112, a plucker can rotate in a plane that is generally perpendicular to the emitter 112. A lip or similar structure can engage the emitter electrode 112 when the plucker is rotated toward the emitter electrode 112. Then, when the plucker is rotated away from the emitter electrode 112, the emitter electrode 112 will vibrate, thereby causing at least a portion of the debris that accumulates on the emitter electrode 112 to shake free. In still another embodiment, a plucker can pluck the emitter electrode 112 when it is rotated toward and past the emitter electrode 112.

In embodiments including more than one emitter electrode 112, there can be a separate plucker 501 for each electrode 112. Alternatively, a single plucker can be made to pluck multiple emitter electrodes at once.

As mentioned above, the first end 503 of the plucker 501 can extend outside the housing 102, thereby enabling a user to manually operate the plucker 501. Alternatively, the plucker 501 can be controlled by, an electromagnetic solenoid or a piezoelectric actuator mechanism, similar to the mechanism 311 discussed above with reference to FIG. 28. Other ways of, and mechanisms for, controlling the plucker 501 are also within the spirit and scope of the present invention.

Where a solenoid or actuator mechanism is used, a button to activate the mechanism can be placed on the system housing (e.g., 102). In another embodiment, the solenoid or actuator can be activated periodically, or activated in response to some event, such as detection of arcing, or detection of the system being turned on, etc. In accordance with an embodiment of the present invention, an indicator (e.g., a light) can tell a user when they should manually use the plucker 501 to clean the emitter electrode(s) 112.

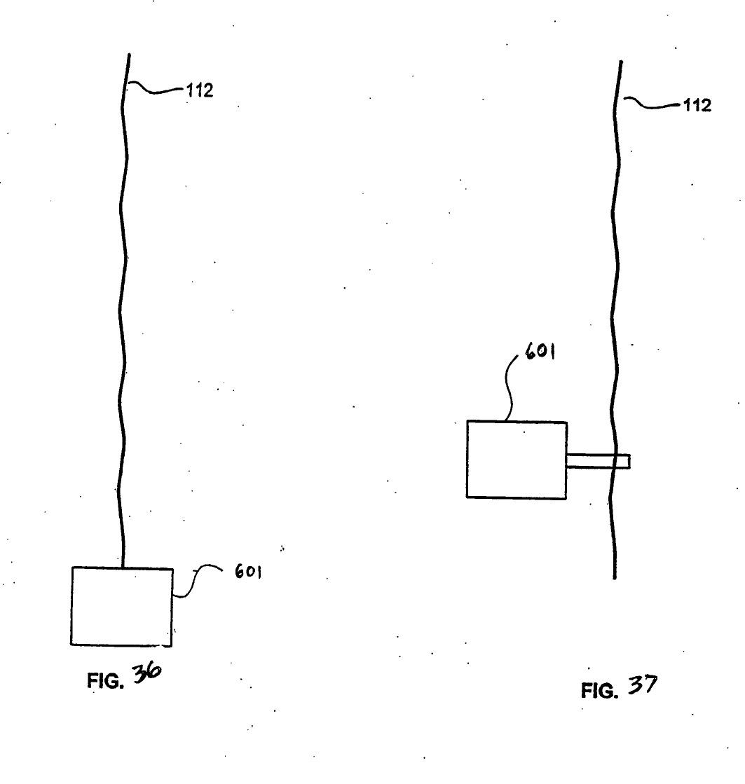

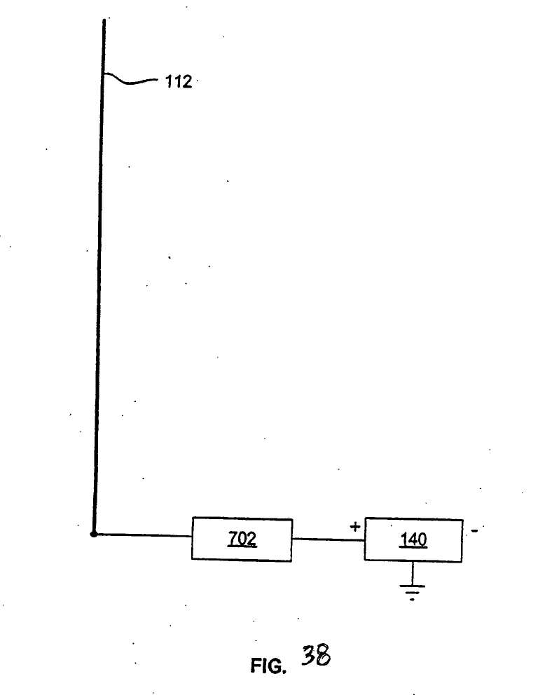

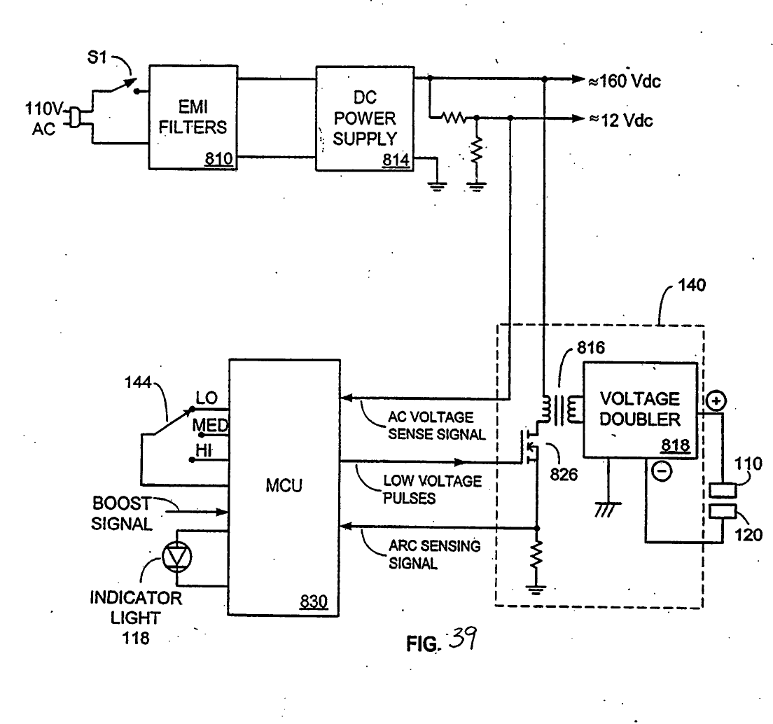

There are other schemes for vibrating an emitter electrode 112, to cause debris to shake free from the emitter electrode 112. For example, a vibrating unit 601 can be connected to one end of the emitter electrode 112, as shown in FIG. 36. Alternatively, the vibrating unit 601 can be connected somewhere along the length of the emitter electrode, as shown in FIG. 37. The vibrating unit 601 can include a piezoelectric vibrator. In another example, the vibrating unit 601 can include a simple DC motor with an eccentric weight connected to the rotor shaft of the DC motor. In another embodiment, the rotor of the DC motor is eccentric, to thereby produce vibration. Alternatively, the vibrating unit 601 can use electro-magnetics to produce vibration. In another example, the vibrating unit 601 includes a vibratory gyroscope. These are just a few examples of how the vibrating unit 601 can vibrate the emitter electrode 112. Other mechanisms for vibrating the emitter electrode 112 are also within the spirit and scope of the present invention.

In embodiments including more than one emitter electrode 112, there can be a separate vibrating unit 601 for each emitter electrode 112. Alternatively, a single vibrating unit 601 can be used to vibrate multiple, and possible all, of the emitter electrodes 112.

A button to activate the vibrating unit 601 can be placed on the system housing (e.g., 102). In another embodiment, the vibrating unit 601 can be activated periodically, or activated in response to some event, such as detection of arcing, or detection of the system being turned on, etc. In accordance with an embodiment of the present invention, an indicator (e.g., a light) can tell a user when they should press the button that will activate the vibrating unit 601.

In another embodiment, a sufficient current is applied to an emitter electrode 112 so as to heat the emitter electrode 112 to a sufficient temperature to cause debris collected on the emitter electrode to be burned off. This can be accomplished, e.g., by connecting a current control circuit 702 between the voltage source 140 and the emitter electrode 112, as shown in FIG. 38. Using simple transistors and/or resistors, the current control circuit 702 can provide one current/voltage to the emitter electrode(s) 112 when the emitter electrode(s) 112 is being used to charged particles, in the manner discussed above. The current control circuit 702 can provide a different current/voltage (likely, a significantly higher current) to heat up the emitter electrode(s) 112, thereby cleaning the emitter electrode(s) 112.

A button to initiate electrode heating can be placed on the system housing 102. In another embodiment, the current control unit 702 can be instructed to cause the heating of the emitter electrode(s) 112 periodically, or in response to some event, such as detection of arcing, or detection of the system being turned on, etc. In accordance with an embodiment of the present invention, an indicator (e.g., a light) can tell a user when they should press the button that will initiate the heating of the emitter electrode(s) 112.

FIG. 39 illustrates an electrical block diagram for driving the electro-kinetic systems described above, according to embodiments of the present invention. An electrical power cord that plugs into a common electrical wall socket provides a nominal 110 VAC. An electromagnetic interference (EMI) filter 810 is placed across the incoming nominal 110 VAC line to reduce and/or eliminate high frequencies generated by the various circuits. Batteries can alternatively be used to power systems, as would be clear to one of ordinary skill in the art.

A DC Power Supply 814 is designed to receive the incoming nominal 110 VAC and to output a first DC voltage (e.g., 160 VDC) for the high voltage generator 140. The first DC voltage (e.g., 160 VDC) is also stepped down through a resistor network to a second DC voltage (e.g., about 12 VDC) that a micro-controller unit (MCU) 830 can monitor without being damaged. The MCU 830 can be, for example, a Motorola 68 HC908 series micro-controller, available from Motorola. In accordance with an embodiment of the present invention, the MCU 830 monitors the stepped down voltage (e.g., about 12 VDC), which is labeled the AC voltage sense signal in FIG. 39 to determine if the AC line voltage is above or below the nominal 110 VAC, and to sense changes in the AC line voltage. For example, if a nominal 110 VAC increases by 10% to 121 VAC, then the stepped down DC voltage will also increase by 10%. The MCU 830 can sense this increase and then reduce the pulse width, duty cycle and/or frequency of the low voltage pulses to maintain the output power (provided to the high voltage generator 140) to be the same as when the line voltage is at 110 VAC. Conversely, when the line voltage drops, the MCU 830 can sense this decrease and appropriately increase the pulse width, duty cycle and/or frequency of the low voltage pulses to maintain a constant output power. Such voltage adjustment features of the present invention also enable the same unit to be used in different countries that have different nominal voltages than in the United States (e.g., in Japan the nominal AC voltage is 100 VAC).

The high voltage pulse generator 140 is coupled between the first electrode array 110 and the second electrode array 120, to provide a potential difference between the arrays. Each array can include one or more electrodes. The high voltage generator 140 may additionally, or alternatively, apply a voltage potential to the driver electrode array 130. The high voltage pulse generator 140 may be implemented in many ways. In the embodiment shown, the high voltage pulse generator 140 includes an electronic switch 826, a step-up transformer 816 and a voltage multiplier 818. The primary side of the step-up transformer 816 receives the first DC voltage (e.g., 160 VDC) from the DC power supply. An electronic switch receives low voltage pulses (of perhaps 20-25 KHz frequency) from the micro controller unit (MCU) 830. Such a switch is shown as an insulated gate bipolar transistor (IGBT) 826. The IGBT 826, or other appropriate switch, couples the low voltage pulses from the MCU 830 to the input winding of the step-up transformer 816. The secondary winding of the transformer 816 is coupled to the voltage multiplier 818, which outputs high voltages to the emitter and collector electrode arrays 110 and 120. In general, the IGBT 826 operates as an electronic on/off switch. Such a transistor is well known in the art and does not require a further description.

When driven, the generator 140 receives the low input DC voltage (e.g., 160 VDC) from the DC power supply 814 and the low voltage pulses from the MCU 830, and generates high voltage pulses of preferably at least 5 KV peak-to-peak with a repetition rate of about 20 to 25 KHz. Preferably, the voltage multiplier 818 outputs about 6 to 9 KV to the emitter array 110, and about 12 to 18 KV to the collector array 120. It is within the scope of the present invention for the voltage multiplier 818 to produce greater or smaller voltages. The high voltage pulses preferably have a duty cycle of about 10%-15%, but may have other duty cycles, including a 100% duty cycle.

The MCU 830 receives an indication of whether the control dial 144 is set to the LOW, MEDIUM or HIGH airflow setting. The MCU 830 controls the pulse width, duty cycle and/or frequency of the low voltage pulse signal provided to switch 826, to thereby control the airflow output, based on the setting of the control dial 114. To increase the airflow output, the MCU 830 can increase the pulse width, frequency and/or duty cycle. Conversely, to decrease the airflow output rate, the MCU 830 can reduce the pulse width, frequency and/or duty cycle. In accordance with an embodiment, the low voltage pulse signal (provided from the MCU 830 to the high voltage generator 140) can have a fixed pulse width, frequency and duty cycle for the LOW setting, another fixed pulse width, frequency and duty cycle for the MEDIUM setting, and a further fixed pulse width, frequency and duty cycle for the HIGH setting.

The MCU 830 can provide various timing and maintenance features. For example, the MCU 830 can provide a cleaning reminder feature (e.g., a 2 week timing feature) that provides a reminder to clean the emitter electrodes 112 and/or collector electrode 122 (e.g., by causing indicator light 118 to turn on amber, and/or by triggering an audible alarm (not shown) that produces a buzzing or beeping noise). The MCU 830 can also provide arc sensing, suppression and indicator features, as well as the ability to shut down the high voltage generator 140 in the case of continued arcing. The MCU 830 can also initiate the cleaning of the emitter electrode(s) (112, 112′, 112″), periodically, in response to arcing being detected, in response to a button being pressed by a user, etc. For example, referring back to the embodiments of FIGS. 17-20, the MCU 830 can control the rotation of wire loop emitter electrode 112′, e.g., by controlling one or more motors that rotate one or more pulleys 221. Referring back to FIG. 21, the MCU 830 can similarly control the winding and unwinding of emitter electrode 112″. Referring back to FIGS. 22-26, the MCU 830 can control the electromechanical mechanism 311 used to control the plunger 309. The MCU 830 may even control an electromechanical mechanism that appropriately maneuvers the lever 401, of FIGS. 27-30, or the plucker 501 of FIGS. 31-33. In another embodiment, the MCU 830 controls the vibrating unit 601 discussed with reference to FIGS. 34 and 35. The MCU 830 may also control the heating of emitter electrodes 112, e.g., by controlling the current control unit 702, discussed above with reference to FIG. 36.

The MCU 830 can detect arcing in various manners. For example, an arc sensing signal can be provided to the MCU 830, as shown in FIG. 37. The arc sensing signal can be compared to an arcing threshold, to determine when arcing occurs. An arcing threshold may exist for each of the various setting of the control dial 144. For example, there can be a high threshold, a medium threshold and a low threshold. These thresholds can be current thresholds, but it is possible that other thresholds, such as voltage thresholds, can be used.

The arc sensing signal can be periodically sampled (e.g., one every 10 msec) to produce a running average current value. The MCU 830 can perform this by sampling the current at the emitter of the IGBT 826 of the high voltage generator 140 (see FIG. 39). The running average current value can be determined by averaging a sampled value with a previous number of samples (e.g., with the previous three samples). A benefit of using averages, rather than individual values, is that averaging has the effect of filtering out and thereby reducing false arcing detections. However, in alternative embodiments no averaging is used. The average current value can be compared to the appropriate threshold value. If the average current value does not equal or exceed the threshold value, then it is determined that arcing is not occurring. If the average current value is equal to or exceeds the threshold value, then it is determined that arcing is occurring, and the MCU 830 can attempt to stop the arcing by cleaning the emitter electrode using one of the embodiments discussed above.

Alternatively, the MCU 830 may simply turn on an indicator (e.g., indicator light 118) to inform a user that the emitter electrode(s) and collector electrode(s) should be cleaned. The user can then use one of the above described embodiments to clean the emitter electrodes. The collector electrodes are most likely cleaned by manually removing them from the housing, as was discussed above. More detailed and alternative algorithms for detecting arcing are provided in commonly assigned U.S. patent application Ser. No. 10/625,401, entitled “Electro-Kinetic Air Transporter and Conditioner Devices with Enhanced Arcing Detection and Suppression Features,” filed Jul. 23, 2003, which is incorporated herein by reference. Other schemes for detecting arcing are also within the spirit and scope of the present invention.

Many of the above described features of the present invention relate to cleaning emitter electrodes of electro-kinetic air transporter and conditioner devices. However, these features can also be used to clean wire-like emitter electrodes in electrostatic precipitator (ESP) devices that do not electro-kinetically transport air. ESP devices are similar to electro-kinetic air transporter and conditioner devices in that both types of devices electronically condition the air using emitter electrodes, collector electrodes, and possibly driver electrodes. However, ESP devices often rely on a mechanical means for moving air, such as a fan, rather than on electro-kinetic air movement. Nevertheless, debris may similarly accumulate on the emitter electrodes of ESP devices, thereby degrading the efficiency of the ESP system, and possibly producing annoying audible oscillations. Accordingly, the above described emitter cleaning features of the present invention can also be applied to ESP devices. Collectively, electro-kinetic air transporter and conditioner devices and ESP devices will be referred to hereafter simply as air conditioning devices, since both types of devices condition the air by electronically cleaning the air and producing ions.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus for conditioning air, comprising:
a vertically elongated housing;
a vertical wire-shaped emitter electrode, disposed in said housing;
a collector electrode, disposed in said housing;
a voltage generator coupled between the emitter electrode and collector electrode; and
an electrode cleaning mechanism adapted to fictionally remove debris from said wire-shaped emitter electrode as said electrode cleaning mechanism is moved along the emitter electrode when said housing is rotated from an original position.

2. The apparatus of claim 1, wherein said electrode cleaning mechanism comprises a member in which is defined an opening corresponding to said wire-shaped electrode, wherein an inner surface of said opening scrapes against an outer surface of said wire-shaped electrode as said electrode cleaning mechanism is moved.

3. The apparatus of claim 1, wherein said electrode cleaning mechanism comprises a non-conductive member including an opening to substantially surround a portion of said wire-shaped emitter electrode, wherein an inner surface of said opening scrapes against an outer surface of said wire-shaped electrode as said electrode cleaning mechanism is moved.

4. The apparatus of claim 1, wherein said collector electrode is substantially parallel to said wire-shaped emitter electrode.

5. The apparatus of claim 1, further comprising:
a handle connected to said collector electrode;
whereby the collector electrode can be vertically removed from said housing when said handle is moved upward by a user, thereby providing cleaning access to said collector electrode.

6. The apparatus of claim 1, wherein said housing includes a base portion that is wider than a remaining portion of said housing to increase stability of said housing.

7. The apparatus of claim 1, further comprising a control switch located on an upper most surface of said housing, thereby providing easy user access to said control switch.

8. The apparatus of claim 1, wherein said housing includes an inlet vent and an outlet vent.

9. The apparatus of claim 1, wherein said collector electrode is formed from sheet metal.

10. The apparatus of claim 1, wherein said collector electrode is substantially hollow, and
wherein an outer surface area of said collector electrode is significantly greater than outer surface area of said emitter electrode, the outer surface area of the collector electrode providing a substantial area for debris to adhere to.

11. An air conditioner system comprising:
an upstanding, vertically elongated housing having an air inlet vent, an air outlet vent, a top surface that includes an opening through which a user liftable handle is viewable and accessible;
an ion generation unit positioned in said vertically elongated housing; and
wherein said ion generating unit includes a first ion emitter electrode and a second particle collector electrode,
wherein said second particle collector electrode is removable from said vertically elongated housing, using said user liftable handle, through said opening to thereby allow an exposed surface of said second electrode to be cleaned, and is returnable to said vertically elongated housing through said opening, and
wherein said user liftable handle covers said opening when said second particle collector electrode is in an operational position within said vertically elongated housing.

12. The system of claim 11, wherein said first electrode is a wire.

13. The system of claim 11, wherein said second collector electrode includes a plurality of elongated fins extending along the elongated housing.

14. The system of claim 11, wherein said ion generating unit includes a high voltage pulse generator.

15. An air cleaning device comprising:
a housing with a top and a base;
at least one emitter electrode disposed within said housing;
at least one collector electrode disposed within said housing;
at least one pylon to secure each emitter electrode with the base of the housing;
a barrier wall adjacent to the base of the housing and located between the emitter electrode and the collector electrode; and a light source located within the housing that provides germicidal activity.

16. The air cleaning device in claim 15 wherein the barrier wall has a lip.

17. The air cleaning device in claim 15 wherein the pylons include insulation material selected from the group consisting of glass, ceramics, and ceramic-based composites.

18. The air cleaning device in claim 15 wherein the pylons are formed from insulation material selected from the group consisting of glass, ceramics, and ceramic-based composites.

19. The air cleaning device in claim 16, wherein the lip of the barrier wall is coated with insulation material selected from the group consisting of glass, ceramics, and ceramic-based composites.

20. The air cleaning device in claim 16, wherein the lip of the barrier wall is formed from insulation material selected from the group consisting of glass, ceramics, and ceramic-based composites.

21. The air cleaning device in claim 15, wherein the barrier wall is coated with insulation material selected from the group consisting of glass, ceramics, and ceramic-based composites.

22. The air cleaning device in claim 15, wherein the barrier wall is formed from insulation material selected from the group consisting of glass, ceramics, and ceramic-based composites.

23. The air cleaner of claim 16, wherein the pylons and the lip of the barrier wall are coated with an insulating material selected from the group consisting of glass, ceramics, and ceramic-based composites.

24. The air cleaner of claim 16, wherein the pylons and the lip of the barrier wall are formed from an insulating material-selected from the group consisting of glass, ceramics, and ceramic-based composites.

25. The air cleaner of claim 15, wherein the pylons and the barrier wall are coated with an insulating material selected from the group consisting of glass, ceramics, and ceramic-based composites.

26. The air cleaner of claim 15, wherein the pylons and the barrier wall are formed from an insulating material selected from the group consisting of glass, ceramics, and ceramic-based composites.

27. The air cleaner of claim 16, wherein the pylons, the barrier wall, and the lip of the barrier wall are coated with an insulating material selected from the group consisting of glass, ceramics, and ceramic based composites.

28. The air cleaner of claim 16, wherein the pylons, the barrier wall, and the lip of the barrier wall are formed from an insulating material selected from the group consisting of glass, ceramics, and ceramic based composites.

29. An air cleaning device comprising:
a housing with a top and base;
at least one emitter electrode disposed in the housing;
at least one pylon disposed in the base of the housing, to secure the emitter electrode;
at least one collector electrode removably disposed in the housing in order to be cleaned;
a source of high voltage coupled between the emitter electrode and the collector electrode;
a barrier wall situated between the emitter electrode secured in the pylon, and the collector electrode, to avoid high voltage arcing;
a lip on an upper edge of the barrier wall; an object with a bore there through, through which bore the emitter electrode is provided such that the object can travel along and clean the emitter electrode; an object-lifting arm movably attached to the collector electrode and operably engageable with the object to move and raise the object along the emitter electrode as the collector electrode is removed through the top of the housing to be cleaned; and a germicidal light source.

30. The air cleaning device in claim 29, wherein the pylon is coated with insulation material selected from the group consisting of glass, ceramics, and ceramic-based composites.

31. The air cleaning device in claim 29, wherein the pylon is cast from insulation material selected from the group consisting of glass, ceramics, and ceramic-based composites.

32. The air cleaning device in claim 29, wherein the barrier wall is coated with insulation material is selected from the group consisting of glass, ceramics, and ceramic-based composites.

33. The air cleaning device in claim 29, wherein the barrier wall is formed from insulation material selected from the group consisting of glass, ceramics, and ceramic-based composites.

34. The air cleaner of claim 29, wherein the pylons and the barrier wall are coated with an insulating material selected from the group consisting of glass, ceramics, and ceramic-based composites.

35. The air cleaner of claim 29, wherein the pylons and the barrier wall are formed from an insulating material selected from the group consisting of glass, ceramics, and ceramic-based composites.

36. The device of claim 29, wherein at least one of the pylon and the barrier wall are comprised an insulating material.

37. The device of claim 29, wherein at least one of the pylon and the barrier wall are coated with an insulating material.

38. The device of claim 29, wherein said pylon and the barrier wall are comprised of an insulating material.

39. The device of claim 29, wherein said pylon and the barrier wall are coated with an insulating material.

40. An air conditioning system comprising:
a. an emitter wire configured to be movable within a housing, wherein at least a portion of the emitter wire is cleaned when moved; and
b. a collector electrode downstream of the emitter wire in the housing, wherein the collector electrode causes the emitter wire to move when the collector electrode is moved in a desired direction.

41. The system of claim 40, wherein the emitter wire is configured in a loop having at least two pulleys on opposed ends of the loop.

42. The system of claim 40, further comprising a gear mechanism coupled to at least one of the pulleys, the gear mechanism adapted to mesh with a corresponding gear feature of the collector electrode, wherein the gear mechanism rotates the pulley when the collector electrode is moved in a desired direction.

43. The system of claim 40, wherein the emitter wire is configured in a loop and having a first wire portion and a second wire portion, wherein the first wire portion is downstream of the second wire portion.

44. The system of claim 40, wherein the emitter wire is configured in a loop and having a first wire portion and a second wire portion, wherein the first and second wire portions are substantially equidistant upstream of the collector electrode.

45. The system of claim 40, further comprising a cleaning element configured to clean the emitter wire when the emitter wire moves.

46. The system of claim 40, further comprising a cleaning element configured to clean the emitter wire when the emitter wire moves, wherein the cleaning element is a brush.

47. The system of claim 40, further comprising a cleaning element configured to clean the emitter wire when the emitter wire moves, wherein the cleaning element is a scraper.

48. The system of claim 40, further comprising a cleaning element configured to clean the emitter wire when the emitter wire moves, wherein the cleaning element is a rotatable member.

49. An air conditioning system, comprising:
an emitter electrode;
a collector electrode;
a high voltage generator to provide a high voltage potential difference between said
emitter electrode and said collector electrode; a cleaning member associated with said emitter electrode; and
a cleaning member projecting upward along said emitter electrode, wherein said cleaning member frictionally removes debris from said emitter electrode as it projects upward along said emitter electrode.

50. The system of claim 49, wherein said cleaning member include a channel through which said emitter electrode passes.

51. The system of claim 49, wherein said means for projecting said cleaning member upward comprises: a spring; and a plunger mechanism to compress said spring, and said spring to project said cleaning member upward along said emitter electrode when said spring is allowed to expand after being compressed.

52. The system of claim 40, wherein said means for projecting said cleaning member to travel upward comprises:
a lever including a first end and a second end, said second end resting at least partially under said cleaning member; and
a fulcrum positioned between said first and second ends of said lever;
wherein a downward force on said first end of said lever translates to an upward force on said second end of said lever, as said lever pivots about said fulcrum, thereby causing said cleaning member to project upward along said emitter electrode and to frictionally remove debris from said emitter electrode.

53. The system of claim 49, further comprising an actuating means for maneuvering said means for projecting said cleaning member upward.

54. The system of claim 53, further comprising a controller to control said actuating means so that said cleaning member is periodically projected upward along said emitter electrode to remove debris from said emitter electrode.

55. The system of claim 53, further comprising a controller to control said actuating means so that said cleaning member is projected upward along said emitter electrode to remove debris from said emitter electrode, in response to detecting arcing between said emitter electrode and said collector electrode.

56. The system of claim 53, further comprising a button or switch that activates said actuating means.

57. The system of claim 49, wherein said means for projecting said cleaning member upward can be manually operated.

58. The system of claim 57, further comprising an indicator that identifies to a user that they should manually operate said means for projecting said cleaning member upward.

59. The system of claim 49, further comprising: a freestanding housing within which said emitter electrode, said collector electrode, and said high voltage generator are contained, said housing including at least one air vent.

60. An air conditioner device, comprising:
a housing;
a first electrode, disposed in said housing;
a second electrode, removably disposed in said housing; and
a frictional cleaning member for cleaning said first electrode.

61. The device of claim 60, wherein said means for frictionally cleaning includes a length of flexible insulating material.

62. The device of claim 61, wherein said length of flexible insulating material is sufficiently long to span the distance between a removable member that can be lifted from the top of said housing second electrode is at least partially in said housing.

63. The device of claim 62, wherein said length of insulating material includes a first end, associated with said movable member, and a second end that frictionally cleans said first electrode.

64. The device of claim 63, wherein said second end defines a slit within which said first electrode fits when said movable member is disposed at least partially in said housing.

65. The device of claim 61, wherein said length of flexible insulating material comprises a strip or a sheet of flexible insulating material.

66. The device of claim 60, wherein said means for frictionally cleaning includes a length of material.
